(19) United States
(12) Patent Application Publication
(10) Pub. No.: US 2023/0109587 A1
(43) Pub. Date: Apr. 6, 2023

(54) ELECTRONIC DEVICE INCLUDING ANTENNA

(71) Applicant: SAMSUNG ELECTRONICS CO., LTD., Suwon-si (KR)

(72) Inventors: Seokwoo LEE, Suwon-si (KR); Dongryul SHIN, Suwon-si (KR); Jiwoo LEE, Suwon-si (KR); Hyosung KANG, Suwon-si (KR); Woojin CHOI, Suwon-si (KR)

(21) Appl. No.: 17/973,399

(22) Filed: Oct. 25, 2022

Related U.S. Application Data
(63) Continuation of application No. PCT/KR2022/014461, filed on Sep. 27, 2022.

(30) Foreign Application Priority Data
Oct. 5, 2021 (KR) 10-2021-0131891

(51) Int. Cl. H01Q 1/22; H01Q 1/48; H01Q 9/04

(52) U.S. Cl. CPC H01Q 1/2266; H01Q 1/48; H01Q 9/0414

(57) ABSTRACT

An electronic device may include a housing, an antenna structure, and a conductive support member. The housing may provide the exterior of the electronic device. The antenna structure may include a printed circuit board including a first surface and a second surface facing in the opposite direction of the first surface. The antenna structure may include at least one antenna element positioned on the first surface or positioned inside the printed circuit board to be closer to the first surface than to the second surface. The antenna structure may be positioned on the conductive support member. The conductive support member may include a first portion and a second portion. The first portion may be coupled to the antenna structure. The first portion may be coupled to the housing or a support structure positioned in the inner space of the housing. The second portion may extend from the first portion. The second portion, when viewed from above the first surface, may overlap the first surface and may be spaced apart from the first surface.

### CROSS-REFERENCE TO RELATED APPLICATIONS

This application claims priority to International Patent Application PCT/KR2022/014461, filed Sep. 27, 2022, which designates the United States and claims priority to KR Patent Application No. 10-2021-0131891, filed Oct. 5, 2021, the disclosures of which are all hereby incorporated by reference herein in their entireties.

### BACKGROUND

### Field

Various example embodiments relate to an electronic device including an antenna.

### Description of Related Art

As the range of available applications expands, the number of antennas included in electronic devices is increasing.

### SUMMARY

As electronic components for various functions, as well as antennas, are being added, it may be difficult to secure a space for antenna design in an electronic device. In the case of an antenna for transmitting and/or receiving radio waves that have high linearity or are sensitive to path loss, such as a millimeter wave (mmWave), the location for disposing the antenna in the electronic device is inevitably limited, and it may be difficult to secure coverage (or a communication range).

Various example embodiments may provide an electronic device including an antenna capable of securing coverage.

According to an example embodiment, an electronic device may include a housing, an antenna structure, and a conductive support member. The housing may provide the exterior of the electronic device. The antenna structure may include a printed circuit board including a first surface and a second surface facing in the opposite direction of the first surface. The antenna structure may include at least one antenna element positioned on the first surface or positioned inside the printed circuit board to be closer to the first surface than to the second surface. The antenna structure may be positioned on the conductive support member. The conductive support member may include a first portion and a second portion. The first portion may be coupled to the antenna structure. The first portion may be coupled to the housing or a support structure positioned in the inner space of the housing. The second portion may extend from the first portion. The second portion, when viewed from above the first surface, may overlap the first surface and may be spaced apart from the first surface.

According to an example embodiment, an electronic device may include a housing, an antenna structure, and a conductive support member. The housing may provide a front area of the exterior of the electronic device, a rear area of the exterior of the electronic device, and a side area of the exterior of the electronic device. The antenna structure may include a printed circuit board including a first surface facing the side area and a second surface facing in the opposite direction of the first surface. The antenna structure may include at least one antenna element positioned on the first surface or positioned inside the printed circuit board to be closer to the first surface than to the second surface. The at least one antenna element may be configured to form a beam pattern toward the side area. The antenna structure may be positioned on the conductive support member. The conductive support member may include a first portion and a second portion. The first portion may be coupled to the antenna structure. The first portion may be coupled to the housing or a support structure positioned in the inner space of the housing. The second portion may extend from the first portion. The second portion, when viewed from above the first surface, may overlap the first surface and may be spaced apart from the first surface.

An electronic device including an antenna according to various example embodiments may easily secure coverage using a support member for positioning the antenna in the electronic device.

In addition, example effects that may be obtained or predicted by various example embodiments will be disclosed directly or implicitly in the detailed description of the example embodiments. For example, various effects predicted according to various example embodiments will be disclosed in the detailed description to be described later.

### [BRIEF DESCRIPTION OF DRAWINGS]

These and other features, aspects, and advantages will become better understood when the following detailed description is read with reference to the accompanying drawings in which like characters represent like parts throughout the drawings, wherein:

FIG. 1 is a block diagram of an electronic device in a network environment according to an example embodiment.

FIG. 2 is a block diagram illustrating an electronic device in a network environment including a plurality of cellular networks according to an example embodiment.

FIG. 3 is a perspective view of an electronic device 3 in an unfolded state according to an example embodiment.

FIG. 4 illustrates diagrams of an electronic device 3 in a folded state according to an example embodiment.

FIG. 5 is an exploded perspective view of a part of the electronic device in FIG. 3 according to an example embodiment.

FIGS. 6 and 7 are perspective views of an antenna module included in an antenna module assembly according to an example embodiment(s).

FIG. 8 is a perspective view of an antenna module assembly according to an example embodiment.

FIG. 9 is a perspective view illustrating a case, a support structure, an antenna structure, a support member, and an electrical path according to an example embodiment.

FIG. 10 is a diagram illustrating a case, a support structure, an antenna structure, a support member, and an electrical path according to an example embodiment.

FIG. 11 is a cross-sectional view of an electronic device taken along line C-C′ in FIG. 10 according to an example embodiment.

FIG. 12 is a perspective view illustrating a case, a support structure, an antenna structure, a support member, and an electrical path according to various example embodiments.

FIG. 13 is a diagram illustrating a case, a support structure, an antenna structure, a support member, and an electrical path according to various example embodiments.

FIG. 14 is a cross-sectional view of an electronic device taken along line D-D′ in FIG. 13 according to various example embodiments.

FIG. 15 illustrates cross-sectional views of an antenna structure and a support member according to various example embodiments.

FIG. 16 illustrates an EIRP heatmap for the embodiment in FIG. 9 or the embodiment in FIG. 12, and an EIRP heatmap for a comparative example in which a second portion of a support member is omitted according to various example embodiments.

FIG. 17 illustrates a graph showing performance evaluation using a CDF for the embodiment in FIG. 9 or the embodiment in FIG. 12 and a graph showing performance evaluation using a CDF for a comparative example in which a second portion of a support member is omitted according to various example embodiments.

### DETAILED DESCRIPTION

Hereinafter, various embodiments disclosed herein will be described with reference to the accompanying drawings.

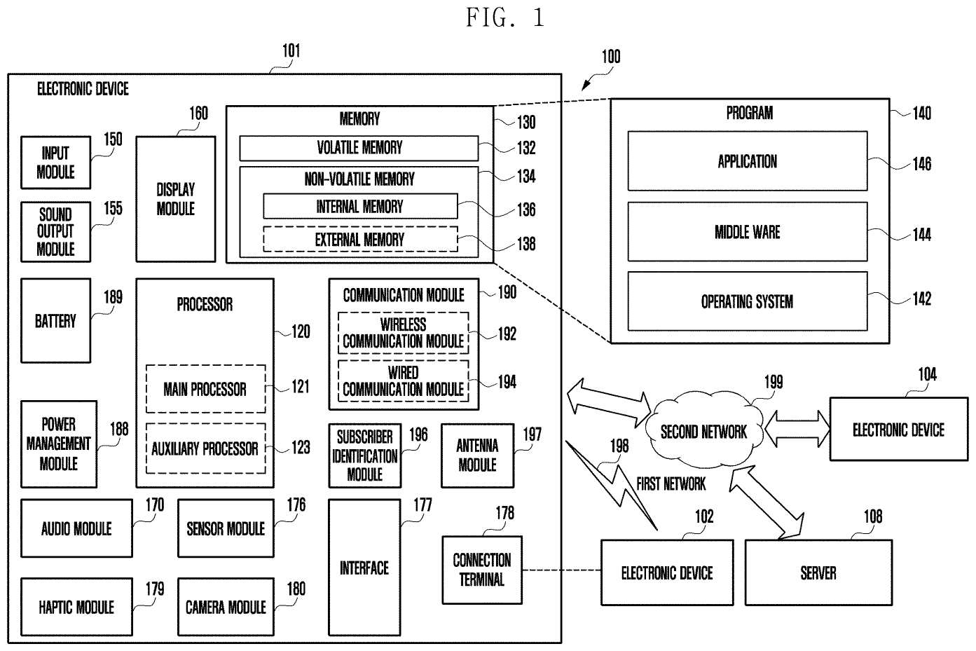

FIG. 1 is a block diagram of an electronic device 101 in a network environment 100 according to an embodiment.

Referring to FIG. 1, the electronic device 101 in the network environment 100 may communicate with an external electronic device 102 via a first network 198 (e.g., a short-range wireless communication network), or at least one of an external electronic device 104 or a server 108 via a second network 199 (e.g., a long-range wireless communication network). The electronic device 101 may communicate with the external electronic device 104 via the server 108. The electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, and/or an antenna module 197. In some embodiments, at least one (e.g., the connection terminal 178) of the components may be omitted from the electronic device 101, or one or more other components may be added in the electronic device 101. In some embodiments, some of the components may be implemented as single integrated circuitry. For example, the sensor module 176, the camera module 180, or the antenna module 197 may be implemented as embedded in single component (e.g., the display module 160).

The processor 120 may execute, for example, software (e.g., a program 140) to control at least one other component (e.g., a hardware or software component) of the electronic device 101 coupled with the processor 120, and may perform various data processing or computation. As at least part of the data processing or computation, the processor 120 may load a command or data received from another component (e.g., the sensor module 176 or the communication module 190) in a volatile memory 132, process the command or the data stored in the volatile memory 132, and store resulting data in a non-volatile memory 134. The processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). The auxiliary processor 123 (e.g., an ISP or a CP) may be implemented as part of another component (e.g., the camera module 180 or the communication module 190) functionally related to the auxiliary processor 123. According to an embodiment, the auxiliary processor 123 (e.g., a neural network processing device) may include a hardware structure specified for processing an artificial intelligence model. The artificial intelligence model may be created through machine learning. Such learning may be performed, for example, in the electronic device 101 itself on which the artificial intelligence model is performed, or may be performed through a separate server (e.g., the server 108). The learning algorithms may include, for example, supervised learning, unsupervised learning, semi-supervised learning, or reinforcement learning, but is not limited thereto. The artificial intelligence model may include a plurality of artificial neural network layers. The artificial neural network may be any of a deep neural network (DNN), a convolutional neural network (CNN), a recurrent neural network (RNN), a restricted Boltzmann machine (RBM), a deep belief network (DBN), a bidirectional recurrent DNN (BRDNN), a deep Q-network, or a combination of two or more of the above-mentioned networks, but is not limited the above-mentioned examples. In addition to the hardware structure, the artificial intelligence model may additionally or alternatively include a software structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 and/or the non-volatile memory 134.

The program 140 may be stored in the memory 130 as software, and may include, for example, an operating system (OS) 142, middleware 144, and/or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing recordings, and the receiver may be used for incoming calls. The receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. The display module 160 may include touch circuitry (e.g., a touch sensor) adapted to detect a touch, or sensor circuitry (e.g., a pressure sensor) adapted to measure the intensity of force incurred by the touch.

The audio module 170 may convert a sound into an electrical signal and vice versa. The audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. The sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. The interface 177 may include, for example, a high-definition multimedia interface (HDMI), a universal serial bus (USB) interface, a secure digital (SD) card interface, and/or an audio interface.

The connecting terminal 178 may include a connector via which the electronic device 101 may be physically connected with the external electronic device (e.g., the external electronic device 102). The connecting terminal 178 may include, for example, an HDMI connector, a USB connector, an SD card connector, and/or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. The haptic module 179 may include, for example, a motor, a piezoelectric element, or an electric stimulator.

The camera module 180 may capture a still image or moving images. The camera module 180 may include one or more lenses, image sensors, ISPs, or flashes.

The power management module 188 may manage power supplied to or consumed by the electronic device 101. The power management module 188 may be implemented as at least part of, for example, a power management integrated circuit (PMIC).

The battery 189 may supply power to at least one component of the electronic device 101. The battery 189 may include, for example, a primary cell which is not rechargeable, a secondary cell which is rechargeable, and/or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more CPs that are operable independently from the processor 120 (e.g., the AP) and supports a direct (e.g., wired) communication or a wireless communication. The communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as BLUETOOTH, wireless-fidelity (Wi-Fi) direct, or IR data association (IrDA)) or the second network 199 (e.g., a long-range communication network, such as a legacy cellular network, a 5th generation (5G) network, a next generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after a 4th generation (4G) network, and next-generation communication technology, e.g., new radio (NR) access technology. The NR access technology may support high-speed transmission of high-capacity data (e.g., enhanced mobile broadband (eMBB)), minimization of terminal power and connection of multiple terminals (massive machine type communications (mMTC)), or high reliability and low latency (ultra-reliable and low-latency communications (URLLC)). The wireless communication module 192 may support a high-frequency band (e.g., a mmWave band) to achieve, for example, a high data transmission rate. The wireless communication module 192 may support various technologies for securing performance in a high-frequency band, such as beamforming, massive multiple-input and multiple-output (MIMO), full-dimensional MIMO (FD-MIMO), array antenna, analog beam-forming, or large-scale antenna. The wireless communication module 192 may support various requirements specified in the electronic device 101, an external electronic device (e.g., external the electronic device 104), or a network system (e.g., the second network 199). According to an embodiment, the wireless communication module 192 may support a peak data rate for implementing eMBB (e.g., 20 Gbps or more), loss coverage for implementing mMTC (e.g., 164 dB or less), or U-plane latency for realizing URLLC (e.g., 0.5 ms or less for each of downlink (DL) and uplink (UL) or 1 ms or less for round trip).

The antenna module 197 may transmit or receive a signal or power to or from the outside (e.g., the external electronic device) of the electronic device 101. The antenna module 197 may include an antenna including a radiating element including a conductive material or a conductive pattern formed in or on a substrate (e.g., a printed circuit board (PCB)). The antenna module 197 may include a plurality of antennas (e.g., an antenna array). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. Another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a PCB, an RFIC that is disposed on or adjacent to a first surface (e.g., the bottom surface) of the PCB and is capable of supporting a predetermined high-frequency band (e.g., a mmWave band), and a plurality of antennas (e.g., array antennas) that is disposed on or adjacent to a second surface (e.g., the top surface or the side surface) of the PCB and is capable of transmitting or receiving a signal of the predetermined high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

Commands or data may be transmitted or received between the electronic device 101 and the external electronic device 104 via the server 108 coupled with the second network 199. Each of the external electronic devices 102 or 104 may be a device of a same type as, or a different type, from the electronic device 101. All or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide an ultra-low delay service using, for example, distributed computing or MEC. In another embodiment, the external electronic device 104 may include an internet of things (IoT) device. The server 108 may be an intelligent server using machine learning and/or neural networks. According to an embodiment, the external electronic device 104 or the server 108 may be included in the second network 199. The electronic device 101 may be applied to an intelligent service (e.g., smart home, smart city, smart car, or healthcare) based on 5G communication technology or IoT-related technology.

An electronic device according to an embodiment may be one of various types of electronic devices. The electronic devices may include a portable communication device (e.g., a smartphone), a computer device, a portable multimedia device, a portable medical device, a camera, a wearable device, or a home appliance. However, the electronic device is not limited to any of those described above.

Various embodiments and the terms used herein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). If an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via at least a third element.

The term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., an internal memory 136 or an external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

A method according to an embodiment may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PLAYSTORE™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

Each component (e.g., a module or a program) of the above-described components may include a single entity or multiple entities. One or more of the above-described components may be omitted, or one or more other components may be added. Alternatively or additionally, a plurality of components (e.g., modules or programs) may be integrated into a single component. In such a case, the integrated component may perform one or more functions of each of the plurality of components in the same or similar manner as they are performed by a corresponding one of the plurality of components before the integration. Operations performed by the module, the program, or another component may be carried out sequentially, in parallel, repeatedly, or heuristically, or one or more of the operations may be executed in a different order or omitted, or one or more other operations may be added.

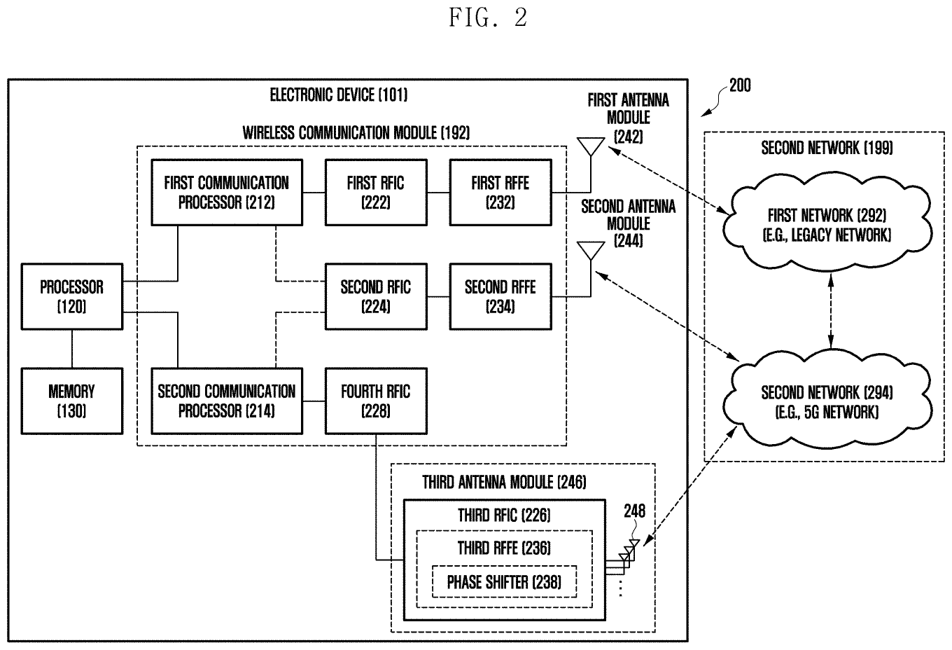

FIG. 2 is a block diagram 200 illustrating an electronic device 101 in a network environment including a plurality of cellular networks according to according to an embodiment.

With reference to FIG. 2, the electronic device 101 may include a first communication processor 212, second communication processor 214, first RFIC 222, second RFIC 224, third RFIC 226, fourth RFIC 228, first radio frequency front end (RFFE) 232, second RFFE 234, first antenna module 242, second antenna module 244, and/or antenna 248. The electronic device 101 may include a processor 120 and a memory 130. A second network 199 may include a first cellular network 292 and a second cellular network 294. According to another embodiment, the electronic device 101 may further include at least one of the components described with reference to FIG. 1, and the second network 199 may further include at least one other network. According to an embodiment, the first communication processor 212, second communication processor 214, first RFIC 222, second RFIC 224, fourth RFIC 228, first RFFE 232, and second RFFE 234 may form at least part of the wireless communication module 192. According to another embodiment, the fourth RFIC 228 may be omitted or included as part of the third RFIC 226.

The first communication processor 212 may establish a communication channel of a band to be used for wireless communication with the first cellular network 292 and support legacy network communication through the established communication channel According to various embodiments, the first cellular network may be a legacy network including a second generation (2G), 3G, 4G, or long term evolution (LTE) network. The second communication processor 214 may establish a communication channel corresponding to a designated band (e.g., about 6 GHz to about 60 GHz) of bands to be used for wireless communication with the second cellular network 294, and support 5G network communication through the established communication channel According to various embodiments, the second cellular network 294 may be a 5G network defined in 3GPP. Additionally, according to an embodiment, the first communication processor 212 or the second communication processor 214 may establish a communication channel corresponding to another designated band (e.g., about 6 GHz or less) of bands to be used for wireless communication with the second cellular network 294 and support 5G network communication through the established communication channel According to an embodiment, the first communication processor 212 and the second communication processor 214 may be implemented in a single chip or a single package. According to various embodiments, the first communication processor 212 or the second communication processor 214 may be formed in a single chip or a single package with the processor 120, the auxiliary processor 123, or the communication module 190.

Upon transmission, the first RFIC 222 may convert a baseband signal generated by the first communication processor 212 to a radio frequency (RF) signal of about 700 MHz to about 3 GHz used in the first cellular network 292 (e.g., legacy network). Upon reception, an RF signal may be obtained from the first cellular network 292 (e.g., legacy network) through an antenna (e.g., the first antenna module 242) and be preprocessed through an RFFE (e.g., the first RFFE 232). The first RFIC 222 may convert the preprocessed RF signal to a baseband signal so as to be processed by the first communication processor 212.

Upon transmission, the second RFIC 224 may convert a baseband signal generated by the first communication processor 212 or the second communication processor 214 to an RF signal (hereinafter, 5G Sub6 RF signal) of a Sub6 band (e.g., 6 GHz or less) to be used in the second cellular network 294 (e.g., 5G network). Upon reception, a 5G Sub6 RF signal may be obtained from the second cellular network 294 (e.g., 5G network) through an antenna (e.g., the second antenna module 244) and be through an RFFE (e.g., the second RFFE 234). The second RFIC 224 may convert the preprocessed 5G Sub6 RF signal to a baseband signal so as to be processed by a corresponding communication processor of the first communication processor 212 or the second communication processor 214.

The third RFIC 226 may convert a baseband signal generated by the second communication processor 214 to an RF signal (hereinafter, 5G Above6 RF signal) of a 5G Above6 band (e.g., about 6 GHz to about 60 GHz) to be used in the second cellular network 294 (e.g., 5G network). Upon reception, a 5G Above6 RF signal may be obtained from the second cellular network 294 (e.g., 5G network) through an antenna (e.g., the antenna 248) and be preprocessed through the third RFFE 236. The third RFIC 226 may convert the preprocessed 5G Above6 RF signal to a baseband signal so as to be processed by the second communication processor 214. According to an embodiment, the third RFFE 236 may be formed as part of the third RFIC 226.

According to an embodiment, the electronic device 101 may include a fourth RFIC 228 separately from the third RFIC 226 or as at least part of the third RFIC 226. In this case, the fourth RFIC 228 may convert a baseband signal generated by the second communication processor 214 to an RF signal (hereinafter, an intermediate frequency (IF) signal) of an intermediate frequency band (e.g., about 9 GHz to about 11 GHz) and transfer the IF signal to the third RFIC 226. The third RFIC 226 may convert the IF signal to a 5G Above 6RF signal. Upon reception, the 5G Above 6RF signal may be received from the second cellular network 294 (e.g., a 5G network) through an antenna (e.g., the antenna 248) and be converted to an IF signal by the third RFIC 226. The fourth RFIC 228 may convert an IF signal to a baseband signal so as to be processed by the second communication processor 214.

According to an embodiment, the first RFIC 222 and the second RFIC 224 may be implemented into at least part of a single package or a single chip. According to an embodiment, the first RFFE, 232 and the second RFFE 234 may be implemented into at least part of a single package or a single chip. According to an embodiment, at least one of the first antenna module 242 or the second antenna module 244 may be omitted or may be combined with another antenna module to process RF signals of a corresponding plurality of bands.

According to an embodiment, the third RFIC 226 and the antenna 248 may be disposed at the same substrate to form a third antenna module 246. For example, the wireless communication module 192 or the processor 120 may be disposed at a first substrate (e.g., main PCB). In this case, the third RFIC 226 is disposed in a partial area (e.g., lower surface) of the first substrate and a separate second substrate (e.g., sub PCB), and the antenna 248 is disposed in another partial area (e.g., upper surface) thereof; thus, the third antenna module 246 may be formed. By disposing the third RFIC 226 and the antenna 248 in the same substrate, a length of a transmission line therebetween can be reduced. This may reduce, for example, a loss (e.g., attenuation) of a signal of a high frequency band (e.g., about 6 GHz to about 60 GHz) to be used in 5G network communication by a transmission line. Therefore, the electronic device 101 may improve a quality or speed of communication with the second cellular network 294 (e.g., 5G network).

According to an embodiment, the antenna 248 may be formed in an antenna array including a plurality of antenna elements that may be used for beamforming. In this case, the third RFIC 226 may include a plurality of phase shifters 238 corresponding to a plurality of antenna elements, for example, as part of the third RFFE 236. Upon transmission, each of the plurality of phase shifters 238 may convert a phase of a 5G Above6 RF signal to be transmitted to the outside (e.g., a base station of a 5G network) of the electronic device 101 through a corresponding antenna element. Upon reception, each of the plurality of phase shifters 238 may convert a phase of the 5G Above6 RF signal received from the outside to the same phase or substantially the same phase through a corresponding antenna element. This enables transmission or reception through beamforming between the electronic device 101 and the outside.

The second cellular network 294 (e.g., 5G network) may operate (e.g., stand-alone (SA)) independently of the first cellular network 292 (e.g., legacy network) or may be operated (e.g., non-stand-alone (NSA)) in connection with the first cellular network 292. For example, the 5G network may have only an access network (e.g., 5G radio access network (RAN) or a next generation (NG) RAN and have no core network (e.g., next generation core (NGC)). In this case, after accessing to the access network of the 5G network, the electronic device 101 may access to an external network (e.g., Internet) under the control of a core network (e.g., an evolved packed core (EPC)) of the legacy network. Protocol information (e.g., LTE protocol information) for communication with a legacy network or protocol information (e.g., new radio (NR) protocol information) for communication with a 5G network may be stored in the memory 130 to be accessed by other components (e.g., the processor 120, the first communication processor 212, or the second communication processor 214).

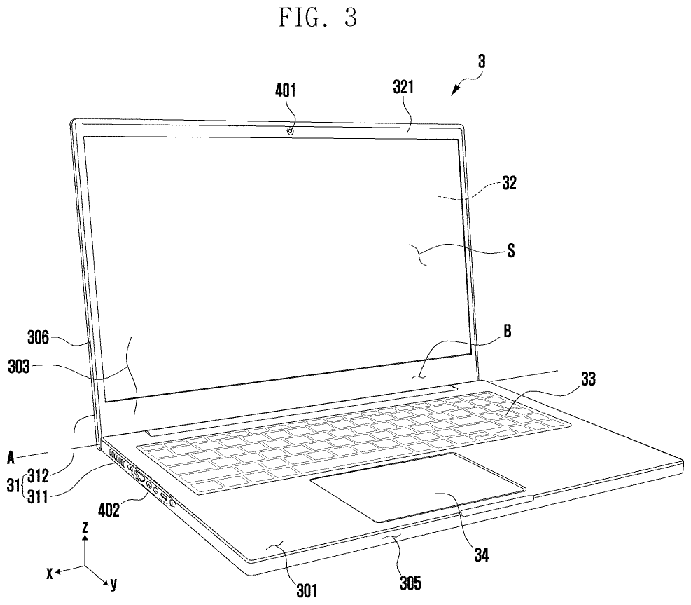

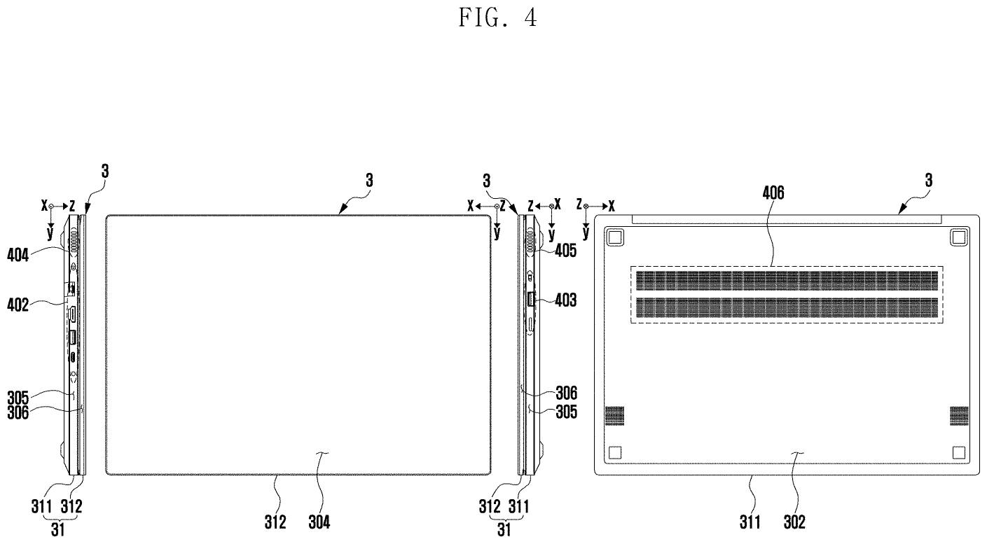

FIG. 3 is a perspective view of an electronic device 3 in an unfolded state according to an embodiment. FIG. 4 is a diagram illustrating an electronic device 3 in a folded state according to an embodiment.

Referring to FIGS. 3 and 4, in an embodiment, the electronic device 3 (e.g., the electronic device 101 in FIG. 1) includes a foldable housing 31, a display 32, a keyboard 33, or a touch pad 34. The electronic device 3 may include, for example, a laptop computer (or a notebook computer).

According to an embodiment, the foldable housing 31 may include a first housing (or a first housing part or a first housing structure) 311, a second housing (or a second housing part or a second housing structure) 312, and/or a hinge assembly. The first housing 311 and the second housing 312 may be coupled by the hinge assembly and may be rotatable relative to each other about a folding axis A (e.g., a rotation axis of the hinge assembly) of the foldable housing 31. The hinge assembly may include at least one hinge connecting the first housing 311 and the second housing 312, and form a folding axis A of the foldable housing 31. The first housing 311 or the second housing 312 may be provided by (or formed of), for example, ceramic, polymer, metal (e.g., aluminum, stainless steel, or magnesium), or a combination of at least two of the above materials. The first housing 311 may at least partially provide (or form) a first front area 301 of the exterior of the electronic device 3 and a first rear area 302 disposed on the opposite side of the first front area 301 of the exterior of the electronic device 3. Coordinate axes shown for ease of understanding are provided based on the first housing 311, for example, the first front area 301 may face substantially in the +z-axis direction, and the first rear area 302 may face substantially in the −z-axis direction. The first housing 311 may at least partially provide (or form) a first side area 305 of the exterior of the electronic device 3, which surrounds at least a part of a space between the first front area 301 and the first rear area 302. The second housing 312 may at least partially provide (or form) a second front area 303 of the exterior of the electronic device 3 and a second rear area 304 disposed on the opposite side of the second front area 303 of the exterior of the electronic device 3. The second housing 312 may at least partially provide (or form) a second side area 306 of the exterior of the electronic device 3, which surrounds at least a portion of a space between the second front area 303 and the second rear area 304. In a certain embodiment, the first housing 311 may refer to a structure that provides (or forms) at least a portion of the first front area 301, the first rear area 302, and the first side area 305. The second housing 312 may refer to a structure that provides (or forms) at least a portion of the second front area 303, the second rear area 304, and the second side area 306. The folded state (see FIG. 4) of the electronic device 3 may indicate the state in which the first housing 311 and the second housing 312 are positioned such that the first front area 301 and the second front area 303 face each other. For example, in the folded state of the electronic device 3, the first front area 301 and the second front area 303 may face each other to form an angle of about 0 degrees to about 10 degrees, and may not be substantially exposed to the outside. In the folded state of the electronic device 3, the first rear area 302 and the second rear area 304 may face in substantially the opposite directions. In the folded state of the electronic device 3, the first side area 305 and the second side area 306 may be aligned with each other. The unfolded state (see FIG. 3) of the electronic device 3 may indicate a state other than the folded state of the electronic device 3.

According to a certain embodiment, the foldable housing 31 may be implemented such that the first housing 311 and the second housing 312 are positioned while the first rear area 302 and the second rear area 304 face each other. In this case, for example, the first rear area 302 and the second rear area 304 may form an angle of about 0 degrees to about 10 degrees and may not be substantially exposed to the outside.

According to an embodiment, the display 32 may be positioned in the second housing 312. For example, the second housing 312 may include a transparent plate 321 that provides (or forms) at least a portion of the second front area 303. The display 32 may be positioned in the inner space of the second housing 312 so as to at least partially overlap the transparent plate 321. The transparent plate 321 may protect the display 32 from the outside. The light output from the display 32 may pass through the transparent plate 321 and proceed to the outside. A screen S of the electronic device 3 may indicate an area capable of displaying an image in a device including the display 32 and the transparent plate 321, and may include, for example, a display area (or active area) of the display 32 and a partial area of the transparent plate 321 overlapping the display area. In a certain embodiment, the transparent plate 321 is an element included in the display 32 and may be provided (or formed) to be integral with the display 32. The transparent plate 321 may include various materials such as polymer or glass. In a certain embodiment, the transparent plate 321 may include a plurality of layers. For example, the transparent plate 321 may be configured as a form in which a coating layer or a protective layer of various polymer materials (e.g., polyester (PET), polyimide (PI), or thermoplastic polyurethane (TPU)) is disposed on a plastic plate or a glass plate. The edge area of the second front area 303 surrounding the screen S may be substantially opaque and provide (or form), for example, a screen bezel B. For example, an opaque material may be disposed on the rear surface of the area corresponding to the screen bezel B of the transparent plate 321. The screen S is not limited to the illustrated example and may be further extended, and may be implemented such that the display area visible through the transparent plate 321 is as large as possible (e.g., a large screen or a full screen). For example, the ratio of the screen S to the second front area 303 may be about 90% or more (e.g., a bezel-less display or a full screen display). In a certain embodiment, the second housing 312 may include a screen bezel B including an opening, and the display 32 may be disposed in the opening to provide (or form) the second front area 303 with the screen bezel B. In a certain embodiment, the display 32 may include a touch sensor (or touch sensing circuit) configured to sense a touch or a pressure sensor configured to measure the strength of a force produced by the touch. In a certain embodiment, the display 32 may include an electromagnetic induction panel (e.g., a digitizer) that detects a magnetic field-type pen input device (e.g., an electronic pen or a stylus pen) or may be coupled to the electromagnetic induction panel.

According to an embodiment, the electronic device 3 may include an input module, a sound output module, a camera module 401, a sensor module, or a plurality of connection terminals 402 and 403. In a certain embodiment, the electronic device 3 may exclude at least one of the elements or further include other elements. The positions or number of the elements included in the electronic device 3 may vary without being limited to the illustrated examples.

The input module may include, for example, a keyboard 33. The keyboard 33 may be positioned in the first housing 311. The first housing 311 may include a plurality of openings (or an opening structure including a plurality of openings) provided (or formed) in the first front area 301, and a plurality of buttons (or keys) of the keyboard 33 may be positioned in the plurality of openings so as to be exposed to the outside. The input module may further include another key input device (e.g., a power button) separate from the keyboard 33. The key input device may be positioned in the first front area 301 or the first side area 305, but is not limited thereto, and the position or number thereof may vary. In a certain embodiment, at least one key input device may be positioned in the second housing 312. In a certain embodiment, at least one key input device may be excluded, and the excluded key input device may be implemented in another form, such as a soft key, on the display 32.

The input module may include, for example, a touch pad 34. The touch pad 34 may be positioned in the first housing 311. The touch pad 34 is a pointing device exposed to the first front area 301 and may include a touch sensing circuit embedded in the surface thereof or disposed on a substrate (not shown) disposed along the surface. The touch pad 34 may include a cover area that at least partially overlaps the substrate including the touch sensing circuit and provides (or forms) a portion of the first front area 301. The cover area may be substantially opaque. The cover area exposed to the outside may provide (or form) a touch input surface for receiving or sensing a touch by user input. For example, if a finger touches the touch input surface or approaches within a threshold distance from the touch input surface, a signal regarding the coordinates may be generated. In a certain embodiment, the cover area providing (or forming) the touch input surface may be interpreted as part of the first housing 311. A click button (e.g., a push switch including a metal dome) may be provided below the touch pad 34. When the touch input surface is pressed, an input may be generated from the push button.

The input module may include, for example, a microphone positioned inside the electronic device 3 and a microphone hole provided (or formed) in the first housing 311 or the second housing 312 corresponding to the microphone. The positions or number of the input modules including the microphone and the microphone hole corresponding thereto may vary. In a certain embodiment, the electronic device 3 may include a plurality of microphones capable of detecting the direction of sound. The microphone hole may be provided (or formed) in, for example, the first side area 305 or the first rear area 302.

The input module may include, for example, at least one sensor. In an embodiment, the input module may include a touch sensor (or touch sensing circuit) or pressure sensor positioned or included in the display 32. In various embodiments, the input module may include, for example, an electromagnetic induction panel (e.g., a digitizer) positioned or included in the display 32.

According to various embodiments, the electronic device 3 may be implemented to exclude some of the input modules or add other input modules according to its provision form or convergence trend. In a certain embodiment, the display 32 including a touch sensor (or touch sensing circuit) or pressure sensor as an input module is not limited to the illustrated example, and may be implemented as a foldable display or a flexible display extended into the first housing 311. For example, in the case where the display 32 is implemented as a flexible display extended to the first housing 311, the flexible display may include a first display area corresponding to the first housing 311, a second display area corresponding to the second housing 312, and a third display area corresponding to a hinge assembly (e.g., a folding part) connecting the first housing 311 and the second housing 312. The third display area may be arranged in an unfolded state or a bent state depending on the angle between the first housing 311 and the second housing 312. In the case where the display 32 is implemented as a flexible display extended to the first housing 311, the keyboard 33 or the touch pad 34 may be omitted. The omitted keyboard 33 or touch pad 34 may be implemented in a form displayed through the flexible display (or the first display area).

The sound output module may include, for example, a speaker positioned inside the electronic device 3 and a speaker hole provided (or formed) in the first housing 311 or the second housing 312 to correspond to the speaker. The speaker hole may be provided (or formed) in, for example, the first side area 305 or the first rear area 302. The positions or number of the sound output modules including the speaker and the speaker hole corresponding thereto may vary. In a certain embodiment, the microphone hole and the speaker hole may be implemented as a single hole. In a certain embodiment, a piezo speaker in which the speaker hole is omitted may be implemented.

The camera module 401, for example, may be positioned inside the second housing 312 corresponding to the screen bezel B. The camera module 401 may include one or more lenses, an image sensor, and/or an image signal processor. The positions or number of the camera modules 401 may vary without being limited to the illustrated example.

According to a certain embodiment, the display 32 may include an opening aligned with the camera module 401. External light may reach the camera module 401 through the transparent plate 321 and the opening of the display 32. In a certain embodiment, the opening of the display 32 may be provided (or formed) in the form of a notch depending on the position of the camera module 401. In a certain embodiment, the camera module 401 may be positioned on the back surface of the display 32, or below or beneath the display 32 to perform related functions (e.g., photographing images) while the position of the camera module 401 is not visually distinguished (or exposed). The camera module 401 may include, for example, a hidden under-display camera (UDC). In a certain embodiment, the camera module 401 may be positioned to be aligned with a recess provided (or formed) on the back surface of the display 32 or to be at least partially inserted into the recess. The camera module 401 may be disposed to overlap at least a portion of the screen S and may obtain an image of an external subject without being visually exposed to the outside. In this case, the partial area of the display 32 at least partially overlapping the camera module 401 may include a pixel structure and/or a wiring structure different from other areas. For example, the partial area of the display 32 at least partially overlapping the camera module 401 may have a pixel density different from those in other areas. The pixel structure and/or wiring structure provided (or configured) in the partial area of the display 32 at least partially overlapping the camera module 401 may reduce light loss between the outside and the camera module 401. In a certain embodiment, the partial area of the display 32 at least partially overlapping the camera module 401 may not have pixels disposed therein. In a certain embodiment, the electronic device 3 may replace the camera module 401 or further include a plurality of camera modules (e.g., a dual camera module or a triple camera module). The plurality of camera modules may have different properties (e.g., angle of view) or functions. For example, the plurality of camera modules may include a plurality of camera modules including lenses having different angles of view, and the electronic device 3 may perform control to change the angle of view of the camera module, based on selection of a user, performed in the electronic device 3. The plurality of camera modules may include at least one of a wide-angle camera, a telephoto camera, a color camera, a monochrome camera, or an infrared (IR) camera (e.g., a time-of-flight (TOF) camera or a structured light camera). In a certain embodiment, the IR camera may operate as at least a part of the sensor module.

The sensor module may generate an electrical signal or data value corresponding to an internal operation state of the electronic device 3 or an external environmental state. The sensor module may include at least one of, for example, a proximity sensor, a gesture sensor, a gyro sensor, an atmosphere pressure sensor, a magnetic sensor, an acceleration sensor, a grip sensor, a color sensor, an infrared (IR) sensor, a biometric sensor (e.g., a fingerprint sensor or an HRM sensor), a temperature sensor, a humidity sensor, or an illuminance sensor.

The plurality of connection terminals 402 and 403 may include, for example, connectors (e.g., an HDMI connector, a USB connector interface, an SD card connector, or an audio connector) positioned inside the electronic device 3 and connector holes provided (or formed) in the first housing 311 to correspond to the connectors. The electronic device 3 may transmit and/or receive power and/or data to and/or from an external electronic device electrically connected, directly or indirectly, to the connector through the connector hole. The positions or number of the connectors and the connector holes corresponding thereto may vary without being limited to the illustrated example.

According to a certain embodiment, the electronic device 3 may include a detachable pen input device (e.g., an electronic pen, a digital pen, or a stylus pen).

According to an embodiment, the foldable housing 31 may include at least one air inlet and at least one air outlet. Outside air may be introduced into the foldable housing 31 through at least one air inlet. Air having received heat radiated from at least one component may be discharged to the outside of the foldable housing 31 through at least one air outlet. In an embodiment, a plurality of openings 404 and 405 provided (or formed) in the first side area 305 may be used as air inlets or air outlets. In an embodiment, a plurality of openings 406 provided (or formed) in the first rear area 302 may be used as air inlets or air outlets.

According to a certain embodiment, not limited to the electronic device 3, various other types of electronic devices may be implemented. The electronic device may include, for example, a portable communication device (e.g., a smartphone), a computer device, a portable multimedia device, a portable medical device, a camera, a wearable device, or home appliances. The electronic device according to the embodiment is not limited to the above-described devices.

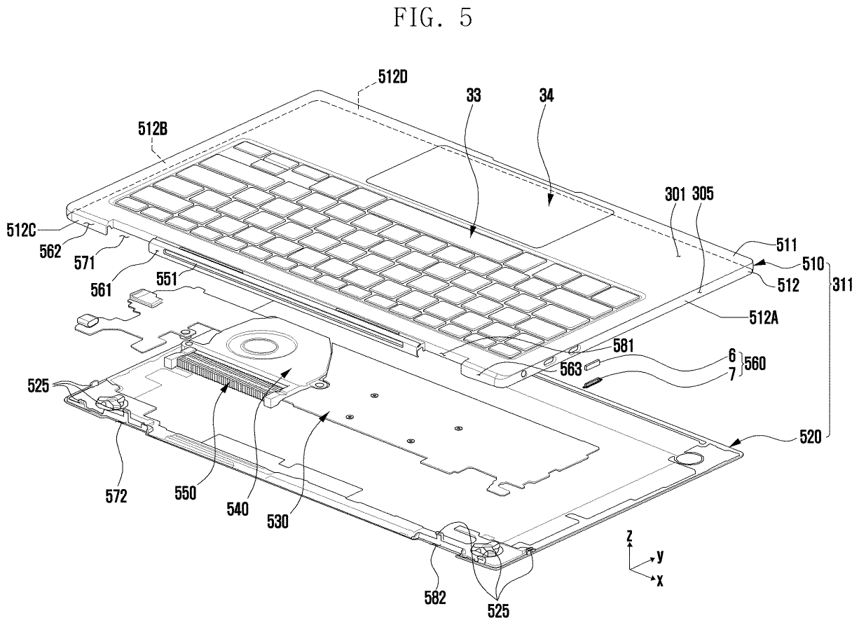

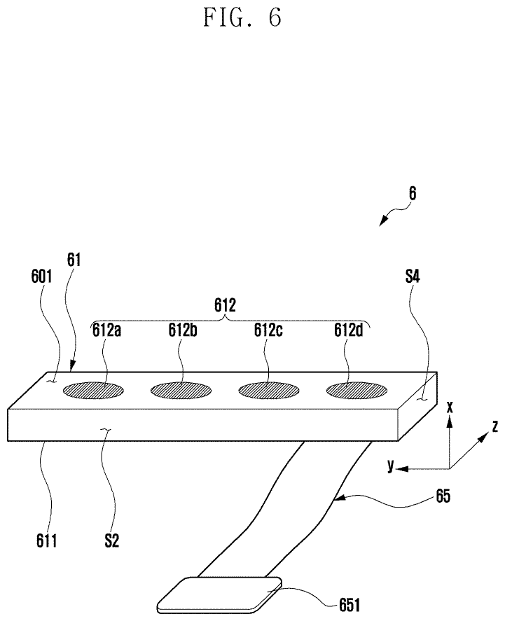

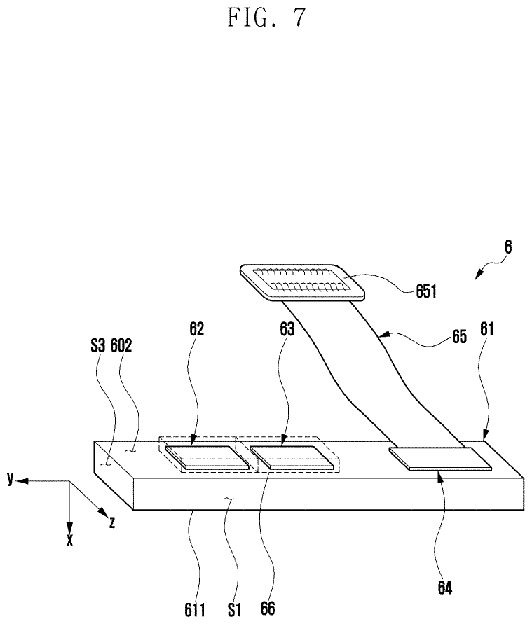

FIG. 5 is an exploded perspective view of a part of the electronic device 3 in FIG. 3 according to an embodiment. FIGS. 6 and 7 are perspective views of an antenna module 8 included in an antenna module assembly 560 according to an embodiment.

Referring to FIG. 5, in an embodiment, the electronic device 3 may include a first housing 311, a keyboard 33, a touch pad 34, a printed circuit board 530, a blower 540, and a first heat conduction member 550, and/or an antenna module assembly 560. In a certain embodiment, the electronic device 3 may exclude at least one of the elements or further include other elements.

According to an embodiment, the first housing 311 may include a case (or a frame) 510 and a back cover (or rear cover) 520. The case 510 may provide at least a portion of the first front area 301 of the electronic device 3 and at least a portion of the first side area 305 of the electronic device 3. The back cover 520 may provide (or form) at least a portion of the first rear area 302 (see FIG. 4) of the electronic device 3 and may be detachable from the case 510. For example, the back cover 520 may include a plurality of hooks 525 for snap-fit fastening with the case 510, and/or a plurality of screw holes (or screw fastening holes) (not shown) for screw fastening (or bolt fastening) with the case 510. The case 510 or the back cover 520 may include, for example, polymer and/or metal (e.g., aluminum, stainless steel, or magnesium).

According to an embodiment, the case 510 may include a front cover 511 and a side structure (or a side member) 512. The front cover 511 and the side structure 512 may be provided (or configured) integrally and may include the same material (e.g., a metal material or a non-metal material). The front cover 511 may be positioned on the opposite side of the back cover 520 in the first housing 311, and a portion of the first front area 301 of the electronic device 3 may be provided (or formed) by the front cover 511. A plurality of buttons of the keyboard 33 may be positioned in a plurality of openings provided (or formed) on the front cover 511 and exposed to the outside. The touch pad 34 may be positioned in an opening provided (or formed) in the front cover 511, and the touch input surface of the touch pad 34 may be exposed to the outside, thereby providing (or forming) a portion of the first front area 301 of the electronic device 3. The side structure 512 may extend from the edge of the front cover 511. The side structure 512 may at least partially surround the space between the front cover 511 and the back cover 520, and at least partially provide (or form) the first side area 305 of the electronic device 3. In a certain embodiment, the front cover 511 and the side structure (or sidewall, sidewall structure, or side member) 512 may be implemented separately.

According to an embodiment, the side structure 512 of the case 510 may include a first side part 512A, a second side part 512B, a third side part 512C, or a fourth side part 512D. The first side part 512A and the second side part 512B may be positioned to be spaced apart from each other in a first direction (e.g., the x-axis direction) and extend substantially parallel to a second direction (e.g., the y-axis direction) when viewed from above the first front area 301 of the electronic device 3 (e.g., when viewed in the −z-axis direction). The third side part 512C may connect one end of the first side part 512A and one end of the second side part 512B. The fourth side part 512D may connect the opposite end of the first side part 512A and the opposite end of the second side part 512B. The third side part 512C and the fourth side part 512D may be positioned to be spaced apart from each other in the second direction and extend substantially parallel to the first direction when viewed from above the first front area 301 of the electronic device 3.

According to an embodiment, the first housing 311 may include a hinge connection structure for rotatable connection with the second housing 312 (see FIG. 3). The hinge connection structure may be provided (or positioned) on one edge of the first housing 311, which is connected to the second housing 312. The hinge connection structure may be positioned, for example, on the side of the third side part 512C of the side structure 512. The hinge connection structure may include, for example, a first hinge arm 561, a second hinge arm 562, a third hinge arm 563, and first recess structures 571 and 572, or second recess structures 581 and 582. The first hinge arm 561, the second hinge arm 562, and the third hinge arm 563 may be provided (or disposed) in the case 510, and the first hinge arm 561 may be positioned between the second hinge arm 562 and the third hinge arm 563. In an embodiment, the first recess structures 571 and 572 may include a notch structure 571 of the case 510 and a notch structure 572 of the back cover 520, and coupling of the notch structures 571 and 572 may provide (or form) a first recess into which a portion of the second housing 312 may be inserted. In an embodiment, the second recess structures 581 and 582 may include a notch structure 581 of the case 510 and a notch structure 582 of the back cover 520, and coupling of the notch structures 581 and 582 may provide (or form) a second recess into which another portion of the second housing 312 may be inserted. A portion of the second housing 312 may be positioned in the first recess by the first recess structures 571 and 572 and may be rotatably coupled to the first hinge arm 561 and the second hinge arm 562 by hinges. Another portion of the second housing 312 may be positioned in the second recess by the second recess structures 581 and 582 and may be rotatably coupled to the first hinge arm 561 and the third hinge arm 563 by hinges. In a certain embodiment, the first recess or the second recess may be implemented by the case 510.

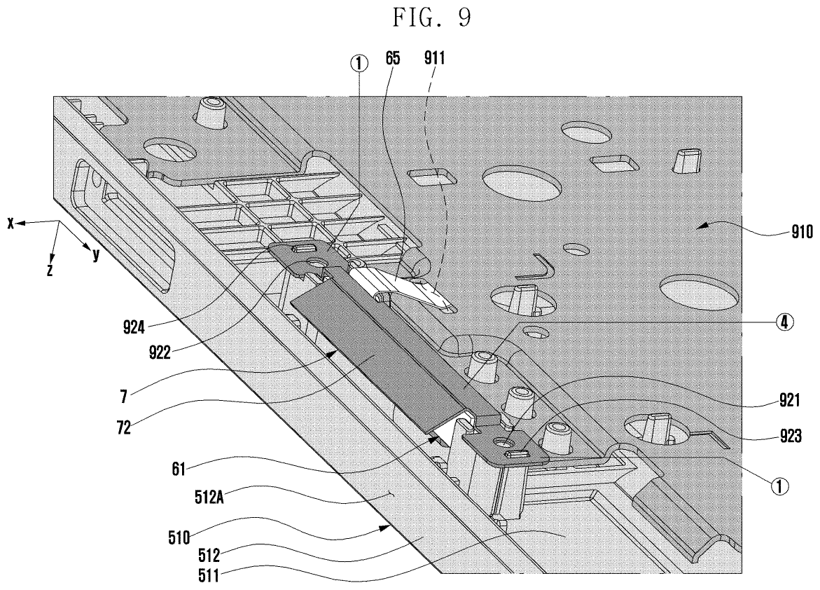

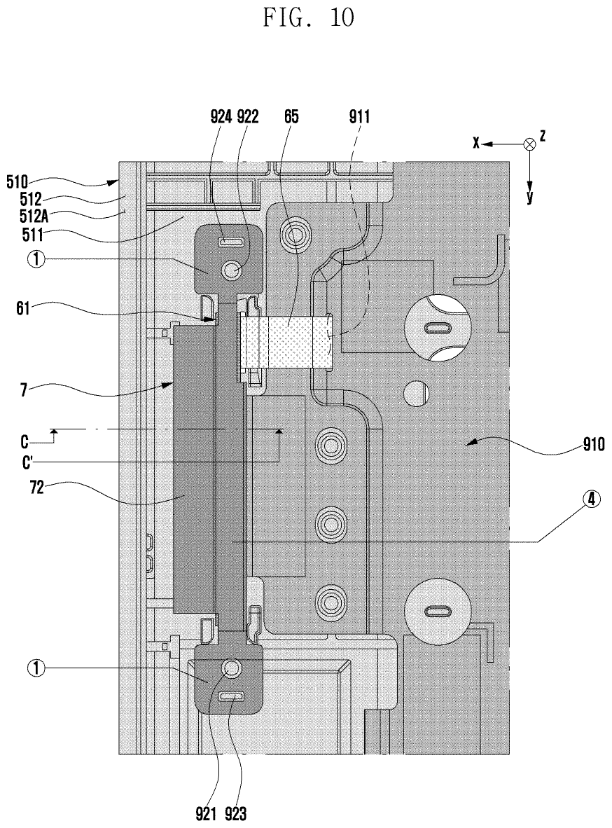

According to an embodiment, the electronic device 3 may include a support structure (e.g., the support structure 910 in FIGS. 9 and 10) positioned between the case 510 and the back cover 520. The support structure, for example, may have elements positioned on, directly or indirectly, the first housing 311 or support elements positioned on, directly or indirectly, the first housing 311. The support structure may contribute to durability or stiffness (e.g., torsional stiffness) of the first housing 311. In a certain embodiment, the support structure may be referred to as various other terms such as “bracket”, “mounting plate”, “support part”, “support member”, or “support plate”. The support structure may be coupled to the case 510 (or the front cover 511 of the case 510) using a fastening structure such as screw fastening. The keyboard 33 and the touch pad 34 may be supported by one surface (hereinafter, referred to as a “first support surface”) facing the first front area 301 of the electronic device 3 in the support structure. The keyboard 33 and the touch pad 34 may be disposed on the first support surface or may be coupled to the front cover 511 of the case 510. The elements such as the printed circuit board 530, the blower 540, or the first heat conduction member 550 may be disposed on the other surface (hereinafter, referred to as a “second support surface”) facing the first rear area 302 (see FIG. 4) of the electronic device 3 in the support structure and may be supported by the support structure. Various components such as a processor, a wireless communication module, a power management module, or a plurality of connection terminals 402 and 403 (see FIG. 4) may be disposed on the printed circuit board 530. The keyboard 33 or the touch pad 34 may be electrically connected to the printed circuit board 530 using an electrical path such as a flexible printed circuit (FPCB). A heat dissipation structure may be positioned in the inner space of the first housing 311 to prevent or reduce at least one component from overheating by dissipating the heat emitted from the at least one element to the outside. The heat dissipation structure may include, for example, a blower 540, a first heat conduction member 550, or a second heat conduction member (not shown). The air flow by the blower 540 may produce a pressure difference between the inner space and the outside of the first housing 311, whereby the outside air (external air) may be introduced into the inner space of the first housing 311 through at least one air inlet (e.g., the plurality of openings 404, 405, and 406 in FIG. 4) provided (or formed) in the first housing 311. The air introduced into the interior of the first housing 311, due to the forced convection by the blower 540, through the air inlet may flow into the air inlet of the blower 540 and may be discharged through the air outlet of the blower 540. The first heat conduction member 550 (e.g., a heat sink) may be coupled to the air outlet of the blower 540 and may be positioned to be aligned with at least one air outlet 551 provided (or formed) in the first side area 305. The second heat conduction member (e.g., a heat spreader, a heat pipe, or a vapor chamber) may receive heat emitted from at least one component. Heat radiated from at least one component may be transferred from the second heat conduction member to the first heat conduction member 550 by heat conduction from a high-temperature part to a low-temperature part. Convection heat transfer, which is an energy transfer method between a solid surface and a gas, may occur between the first heat conduction member 550 and the air, so that heat may be transferred to the outside through at least one air outlet 551 provided (or formed) in the third side part 512c.

According to an embodiment, the antenna module assembly 560 may include an antenna module 6 and a support member 7. The antenna module 6 may be positioned in the inner space of the first housing 311 using the support member 7. The antenna module 8 may be connected, directly or indirectly, to a support structure (e.g., the support structure 910 in FIGS. 9 and 10) positioned in the inner space of the first housing 311 or the first housing 311 using the support member 7. The support member 7 may serve to enable the antenna module 6 to be stably positioned in the inner space of the first housing 311. The support member 7 may contribute to durability for the antenna module 6. The support member 7 is an element for stably positioning the antenna module 6 in the inner space of the first housing (311) and may be referred to as various other terms such as “connection structure”, “connection member”, “bracket”, “antenna module support member”, “antenna module support structure”, “antenna module bracket”, “support part”, or “frame”.

Referring to FIGS. 6 and 7, in an embodiment, the antenna module 6 may include an antenna structure 61, a communication circuit 62, a power management circuit 63, a connector 64, and/or an electrical path 65. The antenna module 6 may be, for example, the third antenna module 246 in FIG. 2.

According to an embodiment, the antenna structure 61 may include a printed circuit board 611 in which an antenna array 612 is disposed or that includes the antenna array 612. The printed circuit board 611 may include a first surface 601 and a second surface 602 facing in the opposite direction of the first surface 601. For example, the first surface 601 and the second surface 602 may be substantially parallel to each other. The antenna array 612 may include a plurality of antenna elements 612a, 612b, 612c, and 612d disposed on the first surface 601 or in the inside of the printed circuit board 611 to be closer to the first surface 601 than to the second surface 602. The plurality of antenna elements 612a, 612b, 612c, and 612d may be, for example, the antenna 248 in FIG. 2. In an embodiment, the plurality of antenna elements 612a, 612b, 612c, and 612d may have substantially the same shape and may be disposed at regular intervals. In an embodiment, the plurality of antenna elements 612a, 612b, 612c, and 612d may transmit and/or receive signals in substantially the same frequency band. The printed circuit board 611 may include a plurality of conductive layers (e.g., a plurality of conductive pattern layers) and a plurality of non-conductive layers (e.g., insulating layers) alternately stacked with the plurality of conductive layers. The plurality of antenna elements 612a, 612b, 612c, and 612d may be implemented as, for example, at least some of the plurality of conductive layers. In a certain embodiment, the number or positions of the antenna elements included in the antenna array 612 may vary without being limited to the embodiment shown in FIG. 6.

According to an embodiment, the plurality of antenna elements 612a, 612b, 612c, and 612d may operate as a patch antenna. In a certain embodiment, the shape of the plurality of antenna elements 612a, 612b, 612c, and 612d may vary without being limited to the circular shape according to the embodiment in FIG. 6. For example, the plurality of antenna elements 612a, 612b, 612c, and 612d may be provided (or configured) in a polygonal shape such as a quadrangle, an ellipse, or an annular shape. In an embodiment, the antenna elements 612a, 612b, 612c, and 612d may be provided (or configured) in a single-layer structure included in the printed circuit board 611. In a certain embodiment, the antenna elements 612a, 612b, 612c, and 612d may be implemented in a stacked structure including a plurality of conductive portions (e.g., conductive patches) positioned on different layers of the printed circuit board 611 to overlap each other. In a certain embodiment, the number or positions of the antenna arrays may vary without being limited to the embodiment shown in FIG. 6. Although not shown, the antenna structure 61 may further include an antenna array including a plurality of antenna elements operating as a dipole antenna. In a certain embodiment, the plurality of antenna elements 612a, 612b, 612c, and 612d may operate as an antenna other than the patch antenna or the dipole antenna.

According to an embodiment, the communication circuit (or wireless communication circuit) 62 may be disposed on the second surface 602 of the printed circuit board 611 using a conductive adhesive material such as solder. For example, the communication circuit 62 may be electrically connected with the plurality of antenna elements 612a, 612b, 612c, and 612d through wires (e.g., an electrical path formed of a conductive pattern or conductive via) included in the printed circuit board 611. As another example, the communication circuit 62 may be disposed on a printed circuit board (e.g., a printed circuit board on which the element such as the processor 120, the memory 130, or the communication module 190 shown in FIG. 1 are disposed, for example, the printed circuit board 530 in FIG. 5) other than the printed circuit board 611. In an embodiment, the communication circuit 62 may include a radio frequency integrate circuit (RFIC). For example, the communication circuit 62 may be the third RFIC 226 in FIG. 2. Each processor herein comprises processing circuitry.

According to an embodiment, the communication circuit 62 may transmit and/or receive signals in at least a partial frequency band of about 3 GHz to about 100 GHz through the antenna array 612. The communication circuit 62 may up-convert or down-convert a frequency of a signal transmitted or received therethrough. The communication circuit 62 may receive an intermediate frequency (IF) signal from a wireless communication circuit (e.g., the wireless communication module 192 in FIG. 1) disposed on another printed circuit board (e.g., the printed circuit board 530 in FIG. 5), and up-convert the received IF signal into a radio frequency (RF) signal (e.g., a millimeter wave). The communication circuit 62 may down-convert an RF signal received through the antenna array 612 into an IF signal, and the IF signal may be provided to a wireless communication circuit (e.g., the wireless communication module 192 in FIG. 1) disposed on another printed circuit board.

According to an embodiment, the plurality of antenna elements 612a, 612b, 612c, and 612d may be fed directly or indirectly from the communication circuit 62 to operate as an antenna radiator.

According to a certain embodiment, the plurality of antenna elements 612a, 612b, 612c, and 612d may be utilized as dummy elements (e.g., dummy antennas, dummy patches, or conductive patches). The dummy element may be physically separated from other conductive elements in an electrically floating state. The antenna module 6 may include a plurality of feed antenna elements (not shown) that, when viewed from above the first surface 601, at least partially overlap the plurality of antenna elements 612a, 612b, 612c, and 612d and are physically separated from the plurality of antenna elements 612a, 612b, 612c, and 612d. The plurality of feed antenna elements may be electrically connected to the communication circuit 62, and the plurality of antenna elements 612a, 612b, 612c, and 612d may be indirectly fed from the plurality of feed antenna elements to operate as an antenna radiator.

According to an embodiment, the antenna structure 61 may include a ground plane (or a ground layer) (not shown) implemented by at least some of a plurality of conductive layers included in the printed circuit board 611. The ground plane may be disposed between the antenna array 612 and the second surface 602, and at least partially overlap the antenna array 612 when viewed from above the first surface 601. In a certain embodiment (not shown), the antenna module 6 may further include an antenna array operating as a dipole antenna. In this case, the ground plane included in the printed circuit board 611 may not overlap the antenna array operating as a dipole antenna.

According to an embodiment, the power management circuit 63 may be disposed on the second surface 602 of the printed circuit board 611 using a conductive adhesive material such as solder. As another example, the power management circuit 63 may be disposed on a printed circuit board (e.g., the printed circuit board 530 in FIG. 5) other than the printed circuit board 611. The power management circuit 63 may be electrically connected to the communication circuit 62 or various other elements (e.g., the connector 64 or a passive element) disposed on the printed circuit board 611 through wires (e.g., an electrical path formed of a conductive pattern or conductive via) included in the printed circuit board 611. In an embodiment, the power management circuit 63 may be a power management integrated circuit (PMIC).

According to an embodiment, the connector 64 may be disposed on the second surface 602 of the printed circuit board 611 using a conductive adhesive material such as solder. One end of the electrical path 65 such as a flexible printed circuit board may be connected, directly or indirectly, to the connector 64 (e.g., a FPCB connector). In a certain embodiment, one end of the electrical path 65 may be electrically connected, directly or indirectly, to conductive terminals (e.g., lands or thin copper pads) positioned on, directly or indirectly, the second surface 602 of the printed circuit board 611 using a conductive adhesive material such as solder, and in this case, the connector 64 may be omitted. The other end of the electrical path 65 may include a connector 651 for electrical connection with another printed circuit board (e.g., a printed circuit board on which the element such as the processor 120, the memory 130, or the communication module 190 shown in FIG. 1 are disposed, for example, the printed circuit board 530 in FIG. 5).

According to a certain embodiment, the antenna module 6 may be construed to exclude at least one element (e.g., the electrical path 65), or one or more other elements may be added to the antenna module 6.

According to a certain embodiment, the antenna module 6 may further include a shielding member (or electromagnetic shielding member) 66 positioned on, directly or indirectly, the second surface 602 to surround at least one of the communication circuit 62 and/or the power management circuit 63. The shielding member 66 may electromagnetically shield the communication circuit 62 and/or the power management circuit 63. The shielding member 66 may include, for example, a conductive member such as a shield can. As another example, the shielding member 66 may include a protective member such as urethane resin, and a conductive paint such as an electromagnetic interference (EMI) paint applied to the outer surface of the protective member. In a certain embodiment, the shielding member 66 may be implemented as various shielding sheets disposed to cover the second surface 602.

According to a certain embodiment (not shown), the antenna module 6 may further include a frequency adjustment circuit disposed on the printed circuit board 611. The frequency adjustment circuit such as a tuner or a passive element may perform impedance matching, shift resonance frequency to a specified frequency, or shift the same by a specified amount.

According to an embodiment, if the antenna module 6 is positioned in the inner space of the first housing 311 using the support member 7, the first surface 601 of the printed circuit board 611 may be directed to the first side part 512A (see FIG. 5) (e.g., the +x-axis direction) of the side structure 512. The antenna module 6 may be positioned in the inner space of the first housing 311 (see FIG. 5) so as to be closer to the first side part 512A (see FIG. 5) than to the second side part 512B of the side structure 512 using the support member 7. The printed circuit board 611 may include a first side surface S1, a second side surface S2, a third side surface S3, or a fourth side surface S4. The first side surface S1 and the second side surface S2 may be positioned on the opposite sides to each other. The third side surface S3 and the fourth side surface S4 may be positioned on the opposite sides to each other. The first side surface S1, the second side surface S2, the third side surface S3, and/or the fourth side surface S4 may be perpendicular to the first surface 601 or the second surface 602. The third side surface S3 or the fourth side surface S4, for example, may be perpendicular to the first side surface S1 or the second side surface S2 when viewed from above the first surface 601 (e.g., in the -x-axis direction). The first side surface S1 may be directed to the front cover 511 of the case 510 or the first front area 301. The second side surface S2 may be directed to the back cover 520 or the first rear area 302 (see FIG. 4). The position of the antenna module assembly 560 is not limited to the illustrated example and may vary. For example, the antenna module assembly 560 is positioned to correspond to the second side part 512B (see FIG. 5), the third side part 512C, or the fourth side part 512D of the side structure 512. As another example, the antenna module assembly 560 may be positioned in the inner space of the second housing 312 (see FIG. 3).

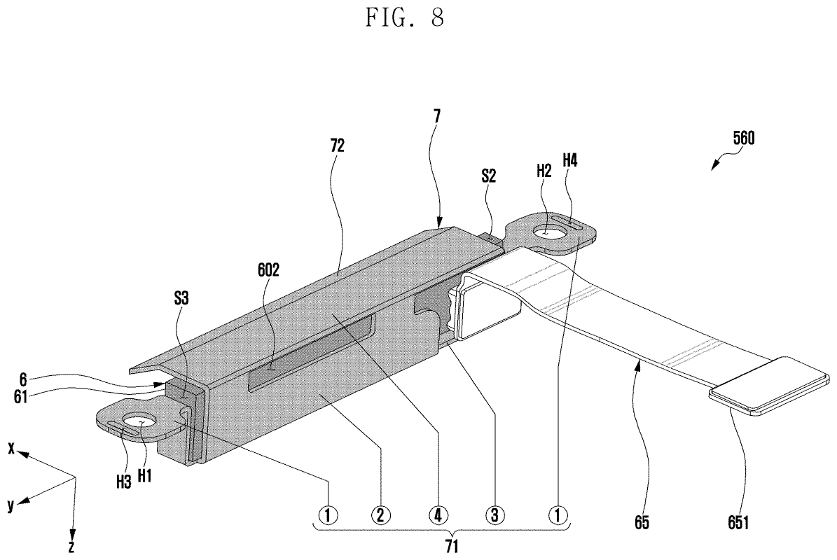

FIG. 8 is a perspective view of an antenna module assembly 560 according to an embodiment. FIG. 9 is a perspective view illustrating a case 510, a support structure 910, an antenna structure 61, a support member 7, and an electrical path 65 according to an embodiment. FIG. 10 is a diagram illustrating a case 510, a support structure 910, an antenna structure 61, a support member 7, and an electrical path 65 according to an embodiment.

Referring to FIGS. 8, 9, and 10, in an embodiment, the antenna module assembly 560 may be coupled to the case 510. The antenna structure 61 may be connected to the case 510 using the support member 7. The support member 7 may be coupled or fixed to the case 510, and the antenna module 6 may be stably positioned in the inner space of the first housing 311 (see FIG. 5) due to the support member 7. In an embodiment, the antenna structure 61 may be positioned to be closer to the first side part 512A (see FIG. 5) than to the second side part 512B, and the first surface 601 (see FIG. 6) of the antenna structure 61 may be directed to the first side part 512A.

According to an embodiment, the support member 7 may include a first portion 71 coupled to the antenna structure 61, and a second portion 72 extending from the first portion 71. In an embodiment, the second portion 72 may affect the electromagnetic wave radiated from the antenna structure 61 to change the coverage (or beam coverage). For example, the electromagnetic wave radiated from the antenna structure 61 may be reflected by the second portion 72 so that the traveling direction thereof may change, and coverage may be formed based on this. The second portion 72 may be referred to as a “reflector”.

According to an embodiment, the first portion 71 of the support member 7 may include a pair of first support parts \textcircled{1}, a second support part \textcircled{2}, a third support part \textcircled{3}, and/or a fourth support part \textcircled{4}. The third support part \textcircled{3} may face, for example, the first side surface S1 (see FIG. 7) of the antenna structure 61, or cover or support the first side surface S1. One of the pair of first support parts \textcircled{1} may extend from the third support part \textcircled{3} to face the third side surface S3 of the antenna structure 61 or to cover or support the third side surface S3. The remaining one of the pair of first support parts \textcircled{1} may extend from the third support part \textcircled{3} to face the fourth side surface S4 (see FIG. 6) of the antenna structure 61 or to cover or support the fourth side surface S4 (see FIG. 6). The second support part \textcircled{2}, for example, may extend from the third support part \textcircled{3} to face the second surface 602 (see FIG. 7) of the antenna structure 61 or to cover or support the second surface 602. The fourth support part \textcircled{4}, for example, may extend from the second support part \textcircled{2} to face the second side surface S2 of the antenna structure 61 or to cover or support the second side surface S2. The third support part \textcircled{3} and the fourth support part \textcircled{4}, when viewed from above the first surface 601 (see FIG. 6) of the antenna structure 61 (e.g., when viewed in the −x-axis direction), may be positioned on, directly or indirectly, the opposite sides to each other and may be perpendicular to the second support part \textcircled{2}. The pair of first support parts \textcircled{1}, when viewed from above the first surface 601 of the antenna structure 61, may be positioned on the opposite sides to each other and may be perpendicular to the second support part \textcircled{2}, the third support part \textcircled{3}, or the fourth support part \textcircled{4}. In an embodiment, the pair of first support parts \textcircled{1} may be positioned symmetrically with respect to the antenna structure 61. The pair of first support parts \textcircled{1}, the second support part \textcircled{2}, the third support part \textcircled{3}, and the fourth support part \textcircled{4} may serve to enable the antenna structure 61 to be stably positioned in the support member 7. In a certain embodiment, as shown in FIGS. 9 and 10, the support member 7 may be modified such that the pair of first support parts \textcircled{1} extends from the fourth support part \textcircled{4}. In a certain embodiment, the support member 7 may be modified such that the pair of first support parts \textcircled{1} extends from the second support part \textcircled{2}.

According to an embodiment, the antenna module assembly 560 may be disposed on the front cover 511 of the case 510. The front cover 511 of the case 510 may include a seating structure capable of stably positioning the support member 7 or the antenna module assembly 560. The seating structure may include, for example, a recess structure or a fitting structure that enables the support member 7 or the antenna module assembly 560 to be stably positioned on the front cover 511 of the case 510 without shaking. In an embodiment, the support member 7 may be coupled to the front cover 511 using a screw. For example, one of the pair of first support parts \textcircled{1} may include a first hole (or a first screw hole or a first screw fastening hole) H1 for screw fastening, and the remaining one of the pair of first support parts \textcircled{1} may include a second hole (or a second screw hole or a second screw fastening hole) for screw fastening. The front cover 511 may include a first screw fastening portion (or first boss) 921 provided (or configured) in the seating structure to correspond to the first hole H1 and a second screw fastening portion (or second boss) 922 provided (or configured) in the seating structure to correspond to the second hole H2. When combining the support member 7 with the front cover 511, the first screw fastening portion 921 may be aligned with the first hole H1 to overlap the same or may be inserted into the first hole H1, and the second screw fastening portion 921 may be aligned with the second hole H2 to overlap the same or may be inserted into the second hole H2. The first screw fastening portion 921 and the second screw fastening portion 922 may include a hole structure having a female thread engaging with a male thread of the screw. The structure in which the first screw fastening portion 921 is fitted into the first hole H1 and the second screw fastening portion 922 is fitted into the second hole H2 may serve to guide the position of the support member 7 coupled to the antenna structure 61 when positioning the support member 7 in the case 510 or to stably place the support member 7 at a specified position of the case 510.

According to an embodiment, one of the pair of first support parts \textcircled{1} may include a third hole H3, and the remaining one of the pair of first support parts \textcircled{1} may include a fourth hole H4. The front cover 511 of the case 510 may include a first insert (or first protrusion) 923 provided (or disposed) in the seating structure corresponding to the third hole H3 and a second insert (or second protrusion) 924 provided (or disposed) in the seating structure corresponding to the fourth hole H4. When the support member 7 is coupled to the front cover 511, the first insert 923 may be fitted into the third hole H3, and the second insert 924 may be fitted into the fourth hole H4. The first insert 923 and the third hole H3 corresponding thereto, and the second insert 924 and the fourth hole H4 corresponding thereto may be used to guide the position of the support member 7 coupled to the antenna structure 61 when positioning the same in the case 510. The first insert 923 and the third hole H3 corresponding thereto, and the second insert 924 and the fourth hole H4 corresponding thereto may serve to enable the support member 7 on which the antenna structure 61 is disposed to be stably placed in a specified position of the case 510. In a certain embodiment, the first insert 923 and the second insert 924 may include a hook structure. The first insert 923 may pass through the third hole H3 and then be hook-fastened with one of the first support parts \textcircled{1}, and the second insert 924 may pass through the fourth hole H4 and then be hook-fastened with the remaining one of the first support parts \textcircled{1}. In a certain embodiment, the first insert 923 and the third hole H3, or the second insert 924 and the fourth hole H4 may be omitted.

According to a certain embodiment, the support member 7 and the front cover 511 of the case 510 may be fastened by snap-fitting therebetween. For example, when the support member 7 is positioned on, directly or indirectly, the seating structure of the front cover 511, at least one hook structure of the seating structure may be fastened with at least one hook fastening structure (or a locking structure) provided (or configured) in the support member 7. In a certain embodiment, the support member 7 may include at least one hook structure, and the seating structure of the front cover 511 may include at least one hook fastening structure corresponding thereto.

According to an embodiment, the support member 7 may be implemented as an integral metal structure including a bent portion. The support member 7 may include, for example, titanium, an amorphous alloy, a metal-ceramic composite material (e.g., cermet), or stainless steel. As another example, the support member 7 may include magnesium, a magnesium alloy, aluminum, an aluminum alloy, a zinc alloy, or a copper alloy. The support member 7 may include various other metal materials. The support member 7 may be implemented using a machining method such as CNC (computer numerical control), die casting, or pressing. In a certain embodiment, the support member 7 in which the antenna structure 61 is disposed may be modified in various forms so as to stably or firmly connecting the antenna structure 61 and the case 510 without being limited to the illustrated example.

According to an embodiment, the second support part \textcircled{2} of the support member 7 may include an opening or recess in which an element (e.g., the communication circuit 62, the power management circuit 63, the connector 64, or the shielding member 66 in FIG. 7) disposed on the second surface 602 of the antenna structure 61 may be positioned.

According to an embodiment, an adhesive member may be positioned between the first portion 71 of the support member 7 and the antenna structure 61. For example, the antenna structure 61 may be coupled, directly or indirectly, to the first portion 71 of the support member 7 using a heat-reactive adhesive material, a photo-reactive adhesive material, a general adhesive, or a double-sided tape. In a certain embodiment, a flexible member, such as a rubber, may be positioned between the first portion 71 of the support member 7 and the antenna structure 61. The adhesive member or the flexible member between the first portion 71 and the antenna structure 61 may reduce the effect of stress on the antenna module assembly 560 (see FIG. 8) when an external impact is applied to the first housing 311 (see FIG. 3).

According to an embodiment, the support structure 910 may be positioned between the front cover 511 and the back cover 520 (see FIG. 5) of the case 510. The support structure 910, for example, may have elements positioned in the first housing 311 or support the elements positioned in the first housing 311. The support structure 910 may contribute to the durability or stiffness (e.g., torsional stiffness) of the first housing 311. The support structure 910 may include, for example, a bracket or a mounting plate. The support structure 910 may be coupled to the front cover 511 of the case 510 using a fastening structure such as screw fastening or snap-fitting including a hook structure. The electrical path 65 may be positioned to pass through, for example, an opening 911 provided (or formed) in the support structure 910 to be electrically connected to another printed circuit board 530 (see FIG. 5) positioned between the front cover 511 of the case 510 and the support structure 910.

According to a certain embodiment, the support member 7 to which the antenna structure 61 is coupled may be coupled to the support structure 910 in various other manners such as snap-fitting or bonding including an organic adhesive layer, not limited to screw fastening. In a certain embodiment, the support structure 910 may be interpreted or referred to as a support member other than the support member 7. In a certain embodiment, the support member 7 may be interpreted or referred to as a support structure other than the support structure 910. In a certain embodiment, the support structure 910 and the support member 7 may be interpreted or referred to as different brackets from each other.

According to a certain embodiment, a flexible member such as rubber may be positioned between the support member 7 and the case 510 or between the support member 7 and the support structure 910. The flexible member may reduce the effect of stress on the antenna module assembly 560 (see FIG. 8), the effect of stress between the support member 7 and the case 510, or the effect of stress between the support member 7 and the support structure 910 when an external impact is applied to the first housing 311 (see FIG. 3).

According to an embodiment, heat radiated from the antenna structure 61 and the electronic components (e.g., the communication circuit 62 or the power management circuit 63 in FIG. 7) disposed in the antenna structure 61 may be transferred to the case 510 and/or the support structure 910 via the support member 7 by heat conduction from a high temperature part to a low temperature part. The case 510 and/or the support structure 910 may serve as, for example, a heat spreader. The support member 7 may be a heat transfer path between the antenna module 6 and the heat spreader (e.g., the case 510 or the support structure 910). Heat diffusion or heat dissipation using the support member 7 and the support structure 910 may prevent or reduce overheating, thereby reducing performance degradation of the antenna structure 61 and electronic components disposed in the antenna structure 61 or damage thereto. At least a portion of the first portion 71 included in the support member 7 may be in physical contact with the front cover 511 of the case 510 and/or the support structure 910. In a certain embodiment, a heat conduction material (or heat conduction member) such as a thermal interface material (TIM) may be interposed between at least a portion of the first portion 71 and the front cover 511 or between at least a portion of the first portion 71 and the support structure 910, thereby improving heat transfer performance In a certain embodiment, a heat conduction material (or heat conduction member) such as a TIM may be interposed between the first portion 71 and the antenna structure 61 or between the first portion 71 and the antenna structure 61, thereby improving heat transfer performance.

According to an embodiment, the first portion 71 of the support member 7 may not overlap the first surface 601 or the antenna array 612 (see FIG. 6) when viewed from above the first surface 601 of the antenna structure 61 (e.g., when viewed in the -x-axis direction), thereby reducing the influence of the support member 7 on the radiation performance of the antenna structure 61. In a certain embodiment, the support member 7 may include a fifth support part (not shown) that covers an area that does not overlap the antenna array 612 of the first surface 601 when viewed from above the first surface 601 of the antenna structure 61. The fifth support part, for example, may be positioned so as not to substantially affect the radiation performance of the antenna structure 61. The fifth support part may extend from at least one of the plurality of first support parts \textcircled{1}, the third support part \textcircled{3}, or the fourth support part \textcircled{4}. In a certain embodiment, the fifth support part may be provided (or formed) in the form of a hook that prevents, or reduces the likelihood of, the antenna structure 61 from being separated in the +x-axis direction.

A beam pattern (or radiation pattern) (e.g., a beam width or a direction of a beam) may be formed by a combination of beams produced by the plurality of antenna elements 612a, 612b, 612c, and 612d (see FIG. 6). The electronic device 3 may perform beam forming through the antenna array 612. The electronic device 3 may store codebook information related to beamforming in a memory (e.g., the memory 130 in FIG. 1). The electronic device 3 may efficiently control (e.g., allocate or arrange) a plurality of beams through the plurality of antenna elements 612a, 612b, 612c, and 612d of the antenna array 612, based on the codebook information. The electronic device 3 may adjust the phase of current supplied to the plurality of antenna elements 612a, 612b, 612c, and 612d of the antenna array 612, based on the codebook information, thereby forming a beam pattern. In an embodiment, the antenna array 612 may form, through beamforming, a beam in which a relatively large amount of energy is emitted in a direction (e.g., the +x-axis direction) toward the first surface 601. For example, the antenna array 612 may form a beam pattern substantially toward the first side part 512A.

According to an embodiment, the second portion 72 of the support member 7 may extend from the fourth support part \textcircled{1} of the first portion 71. In the case where the first portion 71 of the support member 7 is modified in a form different from the illustrated example, the position where the second portion 72 extends to the first portion 71 may not be limited to the illustrated example. In an embodiment, the second portion 72 may be flat and may form an acute angle with the first surface 601. For example, the second portion 72 may at least partially extend between the first side part 512A of the case 510 and the first surface 601 (see FIG. 6) of the antenna structure 61 from the fourth support part \textcircled{4}. The second portion 72 may overlap the first surface 601 when viewed from above the first surface 601 of the antenna structure 61 (e.g., when viewed in the -x-axis direction). The second portion 72 may affect at least a portion of the energy (or electromagnetic waves) radiated from the antenna structure 61, thereby forming a beam pattern modified for different coverage from the beam pattern for coverage in the comparative example in which the second portion 72 is omitted. The beam pattern for (or corresponding to) coverage may include an effective area in which the antenna array 612 (see FIG. 6) is able to radiate or sense electromagnetic waves. The beam pattern for coverage may include, for example, an effective area capable of concentrating electromagnetic wave energy in at least one specified direction or transmitting/receiving waves. In an embodiment, at least a portion of the energy radiated from the antenna structure 61 may be reflected by the second portion 72 to change its travel direction. In a certain embodiment, the second portion 72 may be referred to as various other terms such as a “reflective plate”, a “reflective portion”, or a “reflective area”. There may be various conditions in order for the antenna structure 61 to radiate energy, and the angle of the second portion 72 with respect to the first surface 601 or the shape of the second portion 72 may vary, not limited to the illustrated example, depending on desired coverage. For example, the second portion 72 may be modified into a variety of other shapes, such as curved or bent shapes. As another example, the second portion 72 may be modified to have a right angle or an obtuse angle with the first surface 601. The comparative example in which the second portion 72 is omitted is merely presented to easily explain the embodiment, to help the understanding of the embodiment, and to provide comparison with an embodiment, and thus it does not take precedence over the various example embodiments.

According to an embodiment, the first housing 311 (see FIG. 5) may include a non-conductive area corresponding to the coverage (or beam pattern) formed by the antenna structure 61 and the second portion 72 of the support member 7. The non-conductive area may indicate an area through which radio waves related to a frequency signal pass in the first housing 311 when transmitting or receiving the frequency signal through the antenna array 612 (see FIG. 6) included in the antenna structure 61. In an embodiment, the non-conductive area may be referred to as a “radio frequency (RF) window area”. When a radiation current (or electromagnetic signal) is provided to the antenna structure 61, the antenna array 612 may radiate the provided (or fed) electromagnetic signal, passing through the RF window area, to the outside or receive an electromagnetic signal, passing through the RF window area, from the outside. In an embodiment, the RF window area may include a first non-conductive area of the case 510 that is positioned to at least partially correspond to the coverage formed by the antenna structure 61 and the second portion 72 of the support member 7. In a certain embodiment, the RF window area may include a second non-conductive area of the back cover 520 (see FIG. 5) that is positioned to at least partially correspond to the coverage formed by the antenna structure 61 and the second portion 72 of the support member 7. The RF window area may be formed of a non-conductive material (or include a non-conductive material), thereby reducing the influence of the first housing 311 on the radiation performance or coverage of the antenna module 6. The RF window area of the first housing 311 may include a non-conductive material, and at least some of the remaining areas, excluding the RF window area from the first housing 311, may include a conductive material. In a certain embodiment, the entirety of the first housing 311 may include a substantially non-conductive material.

According to an embodiment, the RF window area of the first housing 311 (see FIG. 5) corresponding to the coverage formed by the antenna structure 61 and the second portion 72 of the support member 7 may be positioned to be spaced apart from the antenna structure 61. An air gap may be provided (or formed) between the RF window area and the antenna structure 61. The air gap between the RF window area and the antenna structure 61 may reduce deformation (e.g., distortion) of the coverage formed by the antenna structure 61 and the second portion 72 of the support member 7. In a certain embodiment, a non-conductive material (not shown) may be positioned between the RF window area and the antenna structure 61. The non-conductive material may have dielectric permittivity that does not substantially affect the coverage formed by the antenna structure 61 and the second portion 72 of the support member 7. The non-conductive material may include, for example, a material having a low dielectric permittivity. The non-conductive material may have dielectric permittivity that affects as much as the coverage formed by the antenna structure 61 and the second portion 72 of the support member 7 does not fall outside of a required range.

According to a certain embodiment, the support member 7 may include a non-conductive structure including a non-metal material (e.g., polymer) and a conductive structure including a metal material. The non-conductive structure may provide (or form) at least a portion of the first portion 71. The conductive structure may provide (or form) at least a portion of the second portion 72. The non-conductive structure may be molded to be coupled to the conductive structure using, for example, insert molding. For another example, the non-conductive structure and the conductive structure may be coupled using screw fastening or bonding including an organic adhesive layer (e.g., a polymer adhesive material or a sealant).

According to a certain embodiment, the support member 7 may include a first conductive structure including a first metal material and a second conductive structure including a second metal material. The first conductive structure may provide (or form) at least a portion of the first portion 71. The second conductive structure may provide (or form) at least a portion of the second portion 72. The first conductive structure and the second conductive structure may be coupled, directly or indirectly, using various connection methods such as screw fastening or bonding. In a certain embodiment, the first conductive structure and the second conductive structure may be electrically connected in various connection methods.

According to an embodiment, the support member 7 may be electrically connected to a ground member (or the ground) included in the electronic device 3 (see FIG. 3). The ground member may include, for example, a ground plane included in the printed circuit board 530, a conductive area included in the support structure 910, or a conductive area included in the case 510. For example, the ground plane (or ground layer) included in the printed circuit board 530 in FIG. 5 may be electrically connected to a conductive area included in the support structure 910 or a conductive area included in the case 510, and the support member 7 may be electrically connected to the ground plane included in the printed circuit board 530 through the conductive area included in the support structure 910 or the conductive area included in the case 510. For example, the first portion 71 of the support member 7 may be electrically connected to the conductive area included in the support structure 910 or the conductive area included in the case 510 using a conductive adhesive member or a flexible conductive member (e.g., a conductive clip, a pogo pin, a spring, the conductive Poron, conductive rubber, a conductive tape, or a conductive connector). In a certain embodiment, there may be an electrical path such as a cable electrically connecting the first portion 71 of the support member 7 and the ground plane included in the printed circuit board 530. The support member 7 electrically connected to the ground member may serve as an electromagnetic shield. For example, the support member 7 may reduce noise introduced from the outside of the electronic device 3 or electromagnetic influences (e.g., EMI) of other electronic components on the antenna module 6. For example, the support member 7 may reduce the electromagnetic influence of the antenna module 6 on other electronic components. Each antenna module herein comprises at least one antenna.

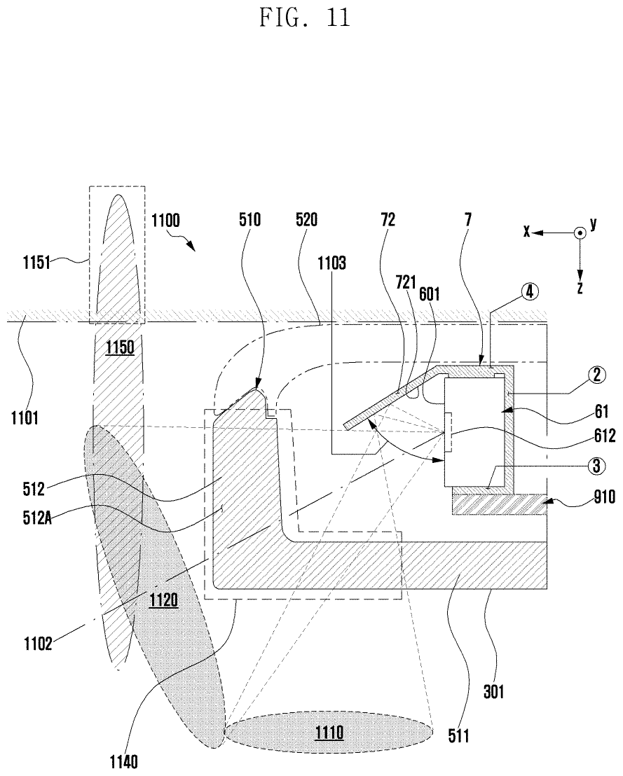

FIG. 11 is a cross-sectional view 1100 of an electronic device 3 (see FIG. 3) taken along line C-C′ in FIG. 10 according to an embodiment.

Referring to FIG. 11, the electronic device 3 may include a case 510, a support structure 910, a support member 7, and an antenna structure 61. In an embodiment, the second portion 72 of the support member 7 may extend from the fourth support part \textcircled{4} of the support member 7 and include a third surface 721 of a plane forming an acute angle with the first surface 601 of the antenna structure 61. The second portion 72 may include, for example, a flat plate shape. The second portion 72 may overlap the first surface 601 when viewed from above the first surface 601 of the antenna structure 61 (e.g., when viewed in the -x-axis direction). In an embodiment, the second portion 72 may overlap the antenna array 612 included in the antenna structure 61 when viewed from above the first surface 601 of the antenna structure 61. In a certain embodiment, the second portion 72 may be positioned so as not to overlap the antenna array 612 when viewed from above the first surface 601 of the antenna structure 61.

Reference numeral “1150” may indicate, for example, coverage corresponding to a beam pattern formed by the antenna structure 61 in a comparative example in which the second portion 72 is omitted. In the case where the first housing 311 (see FIG. 3) is placed on the external object 1101, such as a desk such, that the back cover 520 faces the external object 1101, a portion 1151 of the coverage 1150 according to the comparative example may be positioned corresponding to the external object 1101 to become an ineffective area that makes it difficult to transmit or receive a wave (or electromagnetic wave energy). The coverage 1150 according to the comparative example may not substantially include an effective area corresponding to the first front area 301 (e.g., an exterior area through which the keyboard 33 or touch pad 34 in FIG. 3 is exposed). In an embodiment, the coverage by the antenna structure 61 and the second portion 72 may be formed to secure radio wave transmission/reception performance, compared to the coverage 1150 of the comparative example. Some of the energy (or electromagnetic waves) radiated from the antenna structure 61 may be reflected by the second portion 72, thereby forming a first beam pattern for the first coverage 1110 corresponding to the first front area 301. The first beam pattern may form a first coverage 1110 in a corresponding angular range in the +z-axis direction. Some of the energy radiated from the antenna structure 61 may proceed without substantial reflection by the second portion 72, thereby forming a second beam pattern for the second coverage 1120, which is different from the first coverage 1110. The second beam pattern may form the second coverage 1120 in a corresponding angular range in a direction between the +x-axis direction and the +z-axis direction (e.g., see the direction in which the line indicated by the reference numeral “1102” extends).

The first housing 311 (see FIG. 3), for example, may include an RF window area 1140 of a non-conductive material corresponding to the coverage 1110 and 1120 formed by the antenna structure 61 and the second portion 72 of the support member 7. The RF window area 1140 may reduce degradation of transmission/reception performance of radio waves. In the illustrated example, the RF window area 1140 may include a portion corresponding to a portion of the coverage 1110 and 1120 in the first side part 512A of the case 510, and a portion corresponding to a portion of the coverage 1110 and 1120 in the front cover 511 of the case 510.

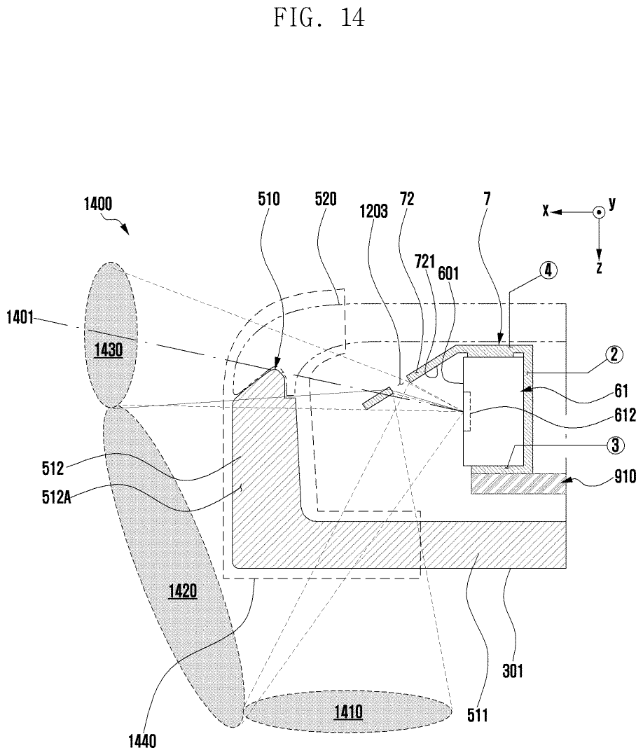

According to a certain embodiment, there may be various conditions in which the antenna structure 61 radiates energy, and the angle 1103 of the second portion 72 with respect to the first surface 601 or the shape of the second portion 72 may vary, not limited to the illustrated example, depending on desired coverage formation. For example, the third surface 721 (see FIG. 11 or 14) of the second portion 72 that the radio wave radiated from the antenna array 612 (see FIG. 6) reaches is not limited to the illustrated planar shape and may be provided (or configured) in various other forms such as a face including irregularities (e.g., a face including a corrugated pattern or a face including a recessed pattern) or a face in which two planes are connected non-parallel.

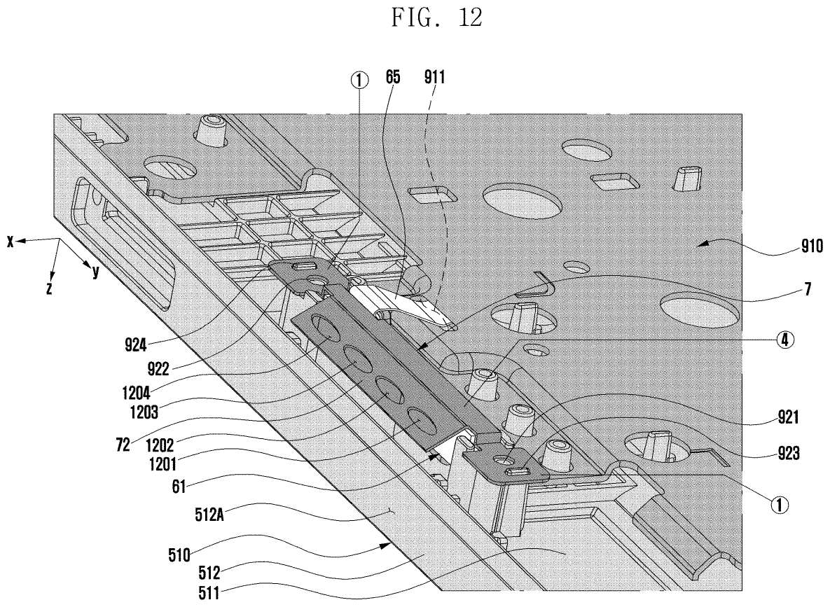

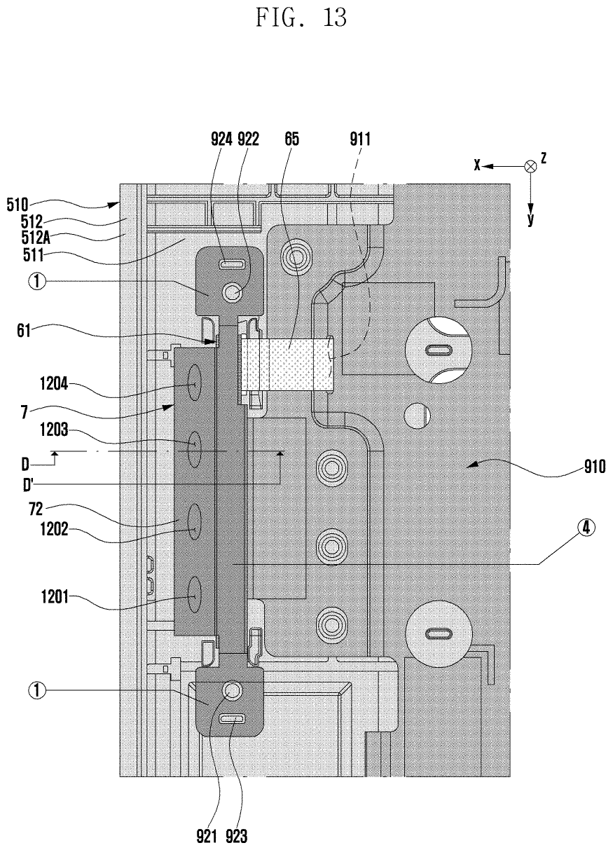

FIG. 12 is a perspective view illustrating a case 510, a support structure 910, an antenna structure 61, a support member 7, and an electrical path 65 according to various embodiments. FIG. 13 is a diagram illustrating a case 510, a support structure 910, an antenna structure 61, a support member 7, and an electrical path 65 according to various embodiments. FIG. 14 is a cross-sectional view 1400 of an electronic device 3 (see FIG. 3) taken along line D-D′ in FIG. 13 according to various embodiments.

The support member 7 according to the embodiment in FIGS. 12, 13, and 14 is another example of a modification of the support member 7 according to the embodiment in FIGS. 9, 10, and 11, and may include a plurality of openings 1201, 1202, 1203, and 1204 provided (or formed) in the second portion 72. Compared to the embodiment in FIGS. 9, 10, and 11, the embodiment in FIGS. 12, 13, and 14 may have more extended coverage due to a plurality of openings 1201, 1202, 1203, and 1204 provided (or formed) in the second portion 72. In an embodiment, the plurality of openings 1201, 1202, 1203, and 1204 may be positioned such that some of the energy radiated from the antenna structure 61 may pass therethrough. In an embodiment, the plurality of openings 1201, 1202, 1203, and 1204 may be positioned to correspond one-to-one to the plurality of antenna elements 612a, 612b, 612c, and 612d (see FIG. 6) included in the antenna array 612. For example, the plurality of openings 1201, 1202, 1203, and 1204 may be aligned one-to-one with the plurality of antenna elements 612a, 612b, 612c, and 612d in the x-axis direction when viewed from above the second side surface S2 (see FIG. 6) of the antenna structure 61 (e.g., when viewed in the +z axis direction).

According to a certain embodiment, a non-conductive dielectric material may be positioned (e.g., filled) in the plurality of openings 1201, 1202, 1203, and 1204 included in the second portion 72 of the support member 7. The non-conductive dielectric material may have dielectric permittivity capable of reducing the influence on the antenna radiation performance or coverage. The non-conductive dielectric material may include, for example, a material having a low dielectric permittivity.

According to a certain embodiment, the shape or position of the opening included in the second portion 72 of the support member 7 may vary without being limited to the illustrated example. For example, some of the plurality of openings may have different shapes from others. For example, the separation distance between any two neighboring openings among the plurality of openings may be constant, or in some cases, may not be constant. In a certain embodiment, the opening may be provided (or configured) in the form of a notch.

According to an embodiment, the coverage formed by the antenna structure 61 and the second portion 72 of the support member 7 may include first coverage 1410, second coverage 1420, and third coverage 1430. Some of the energy (or electromagnetic waves) radiated from the antenna structure 61 may be reflected by the second portion 72, thereby forming a first beam pattern for the first coverage 1410 corresponding to the first front area 301. The first beam pattern may form the first coverage 1410 in a corresponding angular range in the +z-axis direction. Some of the energy radiated from the antenna structure 61 may pass through the plurality of openings 1201, 1202, 1203, and 1204 of the second portion 72, thereby forming a third beam pattern for the third coverage 1430. The third beam pattern may form the third coverage 1430 in a corresponding angular range in a direction between the +x-axis direction and the −z-axis direction (e.g., see the direction in which the line indicated by the reference numeral “1401” extends). Some of the energy radiated from the antenna structure 61 may proceed without substantial reflection by the second portion 72, thereby forming a second beam pattern for the second coverage 1420 between the first coverage 1410 and the third coverage 1430. In an embodiment, the first coverage 1410 may be out-coverage that falls outside of the beam coverage range formed by the antenna structure 61 in the comparative example in which the second portion 72 of the support member 7 is omitted. In an embodiment, the second coverage 1420 and/or the third coverage 1430 may be in-coverage that falls within the beam coverage range formed by the antenna structure 61 in the comparative example in which the second portion 72 of the support member 7 is omitted. In a certain embodiment, the range of the first coverage 1410 may be formed to be wider than the second coverage 1420 and the third coverage 1430 depending on a bent angle of the second portion 72 of the support member 7 (e.g., the angle formed between the second portion 72 and the first surface 601 of the antenna structure 61).

The first housing 311 (see FIG. 3) may include, for example, an RF window area 1440 of a non-conductive material corresponding to the coverage 1410, 1420, and 1430 formed by the antenna structure 61 and the second portion 72 of the support member 7. The RF window area 1440 may reduce degradation of transmission/reception performance of radio waves. In the illustrated example, the RF window area 1440 may include a portion of the first side part 512A of the case 510, which corresponds to a portion of the coverage 1410, 1420, and 1430, a portion of the front cover 511 of the case 510, which corresponds to a portion of the coverage 1410, 1420, and 1430, and a portion of the back cover 520 corresponding to a portion of the coverage 1410, 1420, and 1430. In a certain embodiment, the RF window area 1440 may include a plurality of openings corresponding to the antenna structure 61. A plurality of openings provided (or formed) in the RF window area 1400 may contribute to securing antenna radiation performance or coverage. For example, the side structure 512 may include a plurality of openings, and a non-conductive dielectric material may be positioned (e.g., filled) in the plurality of openings. The non-conductive dielectric material may have a dielectric permittivity capable of reducing the influence on the antenna radiation performance or coverage. The non-conductive dielectric material may include, for example, a material having a low dielectric permittivity.

According to a certain embodiment, there may be various conditions in which the antenna structure 61 radiates energy, and the shape of the second portion 72 corresponding to the antenna structure 61 in the support member 7 or the positional relationship (or relative positions) between the antenna structure 61 and the second portion 72 may be provided (or configured) in various ways, not limited to the illustrated example, depending on the desired coverage.

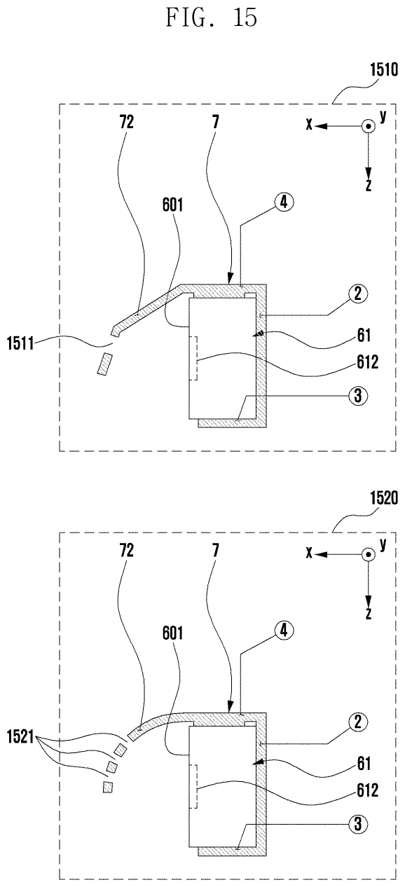

FIG. 15 illustrates cross-sectional views 1510 and 1520 of an antenna structure 61 and a support member 7 according to various embodiments.

In an embodiment, referring to the cross-sectional view 1510, the second portion 72 of the support member 7 may be provided (or configured) in a bent shape rather than a flat shape, compared to the embodiment in FIG. 14. The second portion 72 may include, for example, a first area that forms a first angle with the first surface 601 of the antenna structure 61 and a second area that forms a second angle with the first surface 601 of the antenna structure 61, and include a bent portion between the first area and the second area. In a certain embodiment, the second portion 72 of the support member 7 may be implemented in a form including a plurality of bent portions. The second portion 72 may include one or more openings 1511 positioned to allow some of the energy radiated from the antenna structure 61 to pass therethrough. In a certain embodiment, the second portion 72 may be provided (or configured) in a shape bent in the opposite direction, which is different from the illustrated example.

In another embodiment, referring to the cross-sectional view 1520, the second portion 72 of the support member 7 may be provided (or configured) in a curved shape, compared to the embodiment in FIG. 14. The second portion 72 may include a plurality of openings 1521 positioned to allow some of the energy radiated from the antenna structure 61 to pass therethrough. In a certain embodiment, the second portion 72 may be provided (or configured) in a curved shape that is bent in the opposite direction, which is different from the illustrated example.

According to various embodiments, the second portion 72 including at least one opening in the support member 7 may be provided (or configured) in various other forms without being limited to the illustrated example.

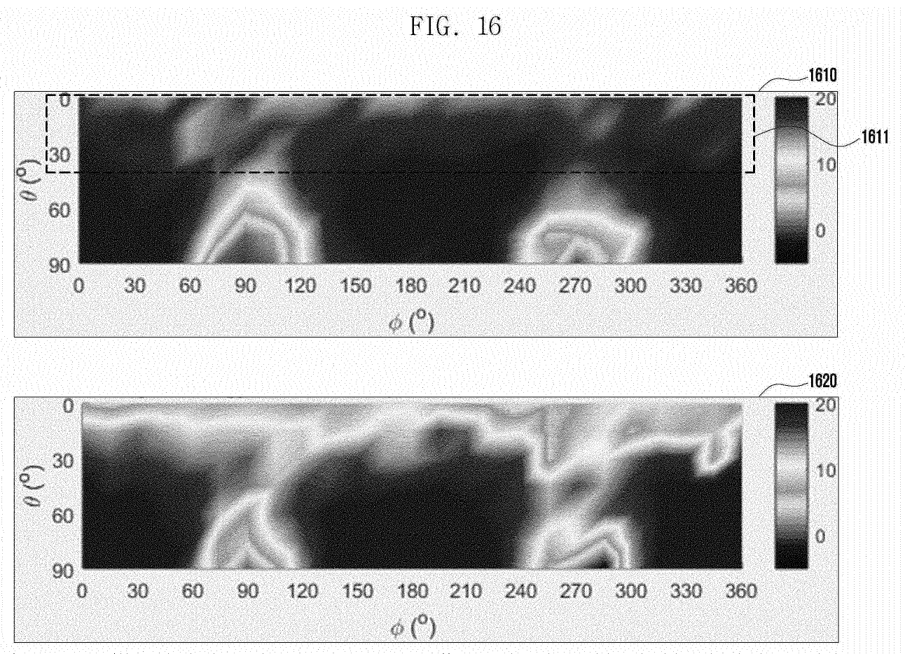

FIG. 16 illustrates an effective isotropically radiate power (EIRP) heatmap 1610 for the embodiment in FIG. 9 or the embodiment in FIG. 12, and an EIRP heatmap 1620 for a comparative example in which a second portion 72 of a support member 7 is omitted according to various embodiments.

Referring to FIG. 16, the embodiment in FIG. 9 or the embodiment in FIG. 12, compared to the comparative example, may secure the amount of radiation corresponding to the first front area 301 (e.g., an exterior area through which the keyboard 33 or touch pad 34 in FIG. 3 is exposed) due to the second portion 72 of the second support member 7 (see reference numeral “1611”).

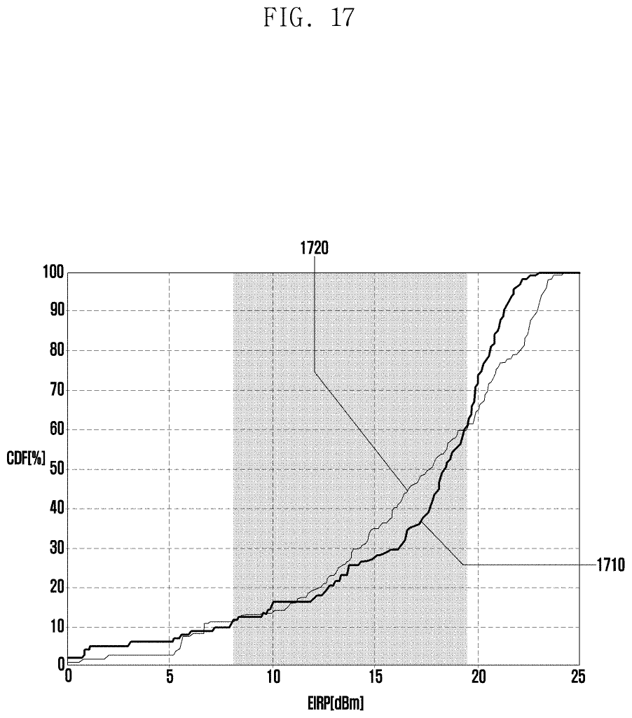

FIG. 17 illustrates a graph 1710 showing performance evaluation (e.g., antenna gain) using a cumulative distribution function (CDF) for the embodiment in FIG. 9 or the embodiment in FIG. 12 and a graph 1720 showing performance evaluation using a CDF for a comparative example in which a second portion 72 of a support member 7 is omitted according to various embodiments.

Referring to FIG. 17, the embodiment in FIG. 9 or the embodiment in FIG. 12, compared to the comparative example, may make it possible to easily secure coverage due to the second portion 72 of the second support member 7 (see the shaded portion corresponding to an EIRP value indicating a criterion of securing performance).

According to a certain embodiment, in the embodiment in FIG. 9 or the embodiment in FIG. 12, the second portion 72 of the support member 7 may also operate as a radiating unit that is indirectly fed by the antenna structure 61 and performs re-radiation, such as a director. The second portion 72 may be electromagnetically coupled to (or indirectly fed by) the antenna array 612 (see FIG. 6) to operate as a radiating unit (or antenna radiator). For example, when a radio wave radiated from the antenna array 612 (see FIG. 6) reaches the third surface 721 (see FIG. 11 or 14) of the second portion 72, an alternating surface current may be excited and flow. The radio wave proceeding and encountering the third surface 721 may reach the third surface 721 that conducts electricity well so that substantially all of the energy may be instantaneously changed into a current on the surface of the conductor. The surface current in the form of alternating current may generate radio waves according to a change in the current.

According to a certain embodiment, the second portion 72 of the support member 7 may operate like a dielectric lens (or electromagnetic lens) that adjusts coverage by focusing or diffusing radio waves. The dielectric lens may focus or diffuse electromagnetic waves just like optical lenses refracting light waves, and coverage may be adjusted by the dielectric lens. In a certain embodiment, the second portion 72 may be formed of a non-conductive material without being limited to a metal material as shown in the illustrated example.

According to a certain embodiment, the antenna module assembly according to the embodiment in FIG. 9 or the embodiment in FIG. 12 is not limited to a foldable electronic device such as the electronic device 3 according to the example in FIG. 3. For example, electronic devices having a bar-type or plate-type appearance, slidable electronic devices, stretchable electronic devices, or rollable electronic devices may include the antenna module assembly according to the embodiment in FIG. 9 or the embodiment in FIG. 12.

According to an example embodiment, an electronic device (e.g., the electronic device 3 in FIG. 3) may include a housing (e.g., the first housing 311 in FIG. 3) configured to provide the exterior of the electronic device. The electronic device may include an antenna structure (e.g., the antenna structure 61 in FIG. 6). The antenna structure may include a printed circuit board (e.g., the printed circuit board 611 in FIG. 6) and at least one antenna element (e.g., the plurality of antenna elements 612a, 612b, 612c, and 612d in FIG. 6). The printed circuit board may include a first surface (e.g., the first surface 601 in FIG. 6) and a second surface (e.g., the second surface 602 in FIG. 7) facing in the opposite direction of the first surface. The at least one antenna element may be positioned on, directly or indirectly, the first surface or may be positioned inside the printed circuit board to be closer to the first surface than to the second surface. The electronic device may include a conductive support member (e.g., the support member 7 in FIG. 8) on which the antenna structure is positioned. The conductive support member may include a first portion (e.g., the first portion 71 in FIG. 8) and a second portion (e.g., the second portion 72 in FIG. 8) extending from the first portion. The first portion may be coupled, directly or indirectly, to the antenna structure and may be coupled, directly or indirectly, to the housing or a support structure (e.g., the support structure 910 in FIG. 9) positioned in the inner space of the housing. The second portion, when viewed from above the first surface, may overlap the first surface and may be spaced apart from the first surface.

According to an example embodiment, the housing (e.g., the first housing 311 in FIG. 3) may provide a front area (e.g., the first front area 301 in FIG. 3) of the exterior of the electronic device, a rear area (e.g., the first rear area 302 in FIG. 4) of the exterior of the electronic device, and a side area (e.g., the first side area 305 in FIG. 3) of the exterior of the electronic device. The first surface (e.g., the first surface 601 in FIG. 11) may face the side area. The at least one antenna element may be configured to form a beam pattern toward the side area.

According to an example embodiment, the electronic device may further include a keyboard (e.g., the keyboard 33 in FIG. 3) positioned in the front area (e.g., the first front area 301 in FIG. 3).

According to an example embodiment, the second portion (e.g., the second portion 72 in FIG. 11) may include a flat plate shape forming an acute or right angle with the first surface (e.g., the first surface 601 in FIG. 11).

According to an example embodiment, the second portion (e.g., the second portion 72 in the cross-sectional view 1520 in FIG. 15) may include a curved shape.

According to an example embodiment, the second portion (e.g., the second portion 72 in the cross-sectional view 1510 in FIG. 15) may have a bent shape.

According to an example embodiment, the second portion (e.g., the second portion 72 in FIG. 11), when viewed from above the first surface (e.g., the first surface 601 in FIG. 11), may overlap the at least one antenna element (e.g., the plurality of antenna elements 612a, 612b, 612c, and 612d in FIG. 6).

According to an example embodiment, the second portion (e.g., the second portion 72 in FIG. 11), when viewed from above the first surface (e.g., the first surface 601 in FIG. 11), may not overlap the at least one antenna element (e.g., the plurality of antenna elements 612a, 612b, 612c, and 612d in FIG. 6).

According to an example embodiment, the second portion (e.g., the second portion 72 in FIG. 12) may include one or more openings (e.g., a plurality of openings 1201, 1202, 1203, and 1204 in FIG. 12).

According to an example embodiment, the one or more openings may include a notch.

According to an example embodiment, the one or more openings (e.g., the plurality of openings 1201, 1202, 1203, and 1204 in FIG. 12), when viewed from above the first surface (e.g., the first surface 601 in FIG. 6), may overlap the at least one antenna element (e.g., the plurality of antenna elements 612a, 612b, 612c, and 612d in FIG. 6).

According to an example embodiment, the one or more openings (e.g., the plurality of openings 1201, 1202, 1203, and 1204 in FIG. 12), when viewed from above the first surface (e.g., the first surface 601 in FIG. 6), may not overlap the at least one antenna element (e.g., the plurality of antenna elements 612a, 612b, 612c, and 612d in FIG. 6).

According to an example embodiment, the at least one antenna element may include a plurality of antenna elements (e.g., the plurality of antenna elements 612a, 612b, 612c, and 612d in FIG. 6). The one or more openings may include a plurality of openings (e.g., the plurality of openings 1201, 1202, 1203, and 1204 in FIG. 12) positioned to correspond one-to-one to the plurality of antenna elements.

According to an example embodiment, the first portion (e.g., the first portion 71 in FIG. 8), when viewed from above the first surface (e.g., the first surface 601 in FIG. 6), may not overlap the at least one antenna element (e.g., the plurality of antenna elements 612a, 612b, 612c, and 612d in FIG. 6).

According to an example embodiment, the first portion (e.g., the first portion 71 in FIG. 8) may be electrically connected to a ground of the electronic device.

According to an example embodiment, an electronic device (e.g., the electronic device 3 in FIG. 3) may include a housing (e.g., the first housing 311 in FIG. 3) configured to provide the exterior of the electronic device. The housing may provide a front area (e.g., the first front area 301 in FIG. 3) of the exterior of the electronic device, a rear area (e.g., the first rear area 302 in FIG. 4) of the exterior of the electronic device, and a side area (e.g., the first side area 305 in FIG. 3) of the exterior of the electronic device. The electronic device may include an antenna structure (e.g., the antenna structure 61 in FIG. 6). The antenna structure may include a printed circuit board (e.g., the printed circuit board 611 in FIG. 6) and at least one antenna element (e.g., the plurality of antenna elements 612a, 612b, 612c, and 612d in FIG. 6). The printed circuit board may include a first surface (e.g., the first surface 601 in FIG. 6) facing the side area and a second surface (e.g., the second surface 602 in FIG. 7) facing in the opposite direction of the first surface. The at least one antenna element may be positioned on, directly or indirectly, the first surface or may be positioned inside the printed circuit board to be closer to the first surface than to the second surface. The at least one antenna element may be configured to form a beam pattern toward the side area. The electronic device may include a conductive support member (e.g., the support member 7 in FIG. 8) on which the antenna structure is positioned directly or indirectly. The conductive support member may include a first portion (e.g., the first portion 71 in FIG. 8) and a second portion (e.g., the second portion 72 in FIG. 8) extending from the first portion. The first portion may be coupled to the antenna structure and may be coupled, directly or indirectly, to the housing or a support structure (e.g., the support structure 910 in FIG. 9) positioned in the inner space of the housing. The second portion, when viewed from above the first surface, may overlap the first surface and may be spaced apart from the first surface.

According to an example embodiment, the second portion (e.g., the second portion 72 in FIG. 11) may include a flat plate shape forming an acute or right angle with the first surface (e.g., the first surface 601 in FIG. 11).

According to an example embodiment, the second portion (e.g., the second portion 72 in FIG. 12) may include one or more openings (e.g., the plurality of openings 1201, 1202, 1203, and 1204 in FIG. 12).

According to an example embodiment, the second portion (e.g., the second portion 72 in FIG. 11), when viewed from above the first surface (e.g., the first surface 601 in FIG. 11), may overlap the at least one antenna element (e.g., the plurality of antenna elements 612a, 612b, 612c, and 612d in FIG. 6).

According to an example embodiment, the second portion (e.g., the second portion 72 in FIG. 11), when viewed from above the first surface (e.g., the first surface 601 in FIG. 11), may not overlap the at least one antenna element (e.g., the plurality of antenna elements 612a, 612b, 612c, and 612d in FIG. 6).

The example embodiments and drawings are merely presented by way of example to easily explain technical content and help understanding of the embodiments, and are not intended to limit the scope of the embodiments. Accordingly, the scope of various example embodiments should be construed to encompass changes and modifications, in addition to the embodiments disclosed herein. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. An electronic device comprising:
a housing configured to provide at least a portion of an exterior of the electronic device;
an antenna structure, comprising a printed circuit board comprising a first surface and a second surface facing in the opposite direction of the first surface, and at least one antenna element positioned on the first surface and/or positioned inside the printed circuit board to be closer to the first surface than to the second surface; and
a conductive support member, comprising conductive material, on which the antenna structure is positioned,
wherein the conductive support member comprises:
a first portion coupled to the antenna structure and coupled to the housing and/or a support structure positioned at least partially in the inner space of the housing, and
a second portion extending from the first portion, overlapping the first surface when viewed from above the first surface, and spaced apart from the first surface.

2. The electronic device of claim 1, wherein the housing is configured provide a front area of the exterior of the electronic device, a rear area of the exterior of the electronic device, and a side area of the exterior of the electronic device,
wherein the first surface faces the side area, and
wherein the at least one antenna element is configured to form a beam pattern toward the side area.

3. The electronic device of claim 2, further comprising a keyboard positioned in the front area.

4. The electronic device of claim 1, wherein the second portion comprises a flat plate shape forming an acute or right angle with the first surface.

5. The electronic device of claim 1, wherein the second portion comprises a curved shape.

6. The electronic device of claim 1, wherein the second portion comprises a bent shape.

7. The electronic device of claim 1, wherein the second portion, when viewed from above the first surface, overlaps the at least one antenna element.

8. The electronic device of claim 1, wherein the second portion, when viewed from above the first surface, does not overlap the at least one antenna element.

9. The electronic device of claim 1, wherein the second portion comprises one or more openings.

10. The electronic device of claim 9, wherein the one or more openings comprise a notch.

11. The electronic device of claim 9, wherein the one or more openings, when viewed from above the first surface, overlap the at least one antenna element.

12. The electronic device of claim 9, wherein the one or more openings, when viewed from above the first surface, do not overlap the at least one antenna element.

13. The electronic device of claim 9, wherein the at least one antenna element comprises a plurality of antenna elements, and
wherein the one or more openings comprise a plurality of openings positioned to correspond one-to-one to the plurality of antenna elements.

14. The electronic device of claim 1, wherein the first portion, when viewed from above the first surface, does not overlap the at least one antenna element.

15. The electronic device of claim 1, wherein the first portion is electrically connected to a ground of the electronic device.

16. An electronic device comprising:
a housing configured to provide at least part of a front area of the exterior of the electronic device, at least part of a rear area of the exterior of the electronic device, and at least part of a side area of the exterior of the electronic device;
an antenna structure comprising a printed circuit board including a first surface facing the side area and a second surface facing in the opposite direction of the first surface, and at least one antenna element positioned on the first surface and/or positioned inside the printed circuit board to be closer to the first surface than to the second surface and configured to form a beam pattern toward the side area; and
a conductive support member, comprising conductive material, on which the antenna structure is positioned,
wherein the conductive support member comprises:
a first portion coupled to the antenna structure and coupled to the housing and/or a support structure positioned at least partially in the inner space of the housing, and
a second portion extending from the first portion, overlapping the first surface when viewed from above the first surface, and spaced apart from the first surface.

17. The electronic device of claim 16, wherein the second portion comprises a flat plate shape forming an acute or right angle with the first surface.

18. The electronic device of claim 16, wherein the second portion comprises one or more openings.

19. The electronic device of claim 16, wherein the second portion, when viewed from above the first surface, overlaps the at least one antenna element.

20. The electronic device of claim 16, wherein the second portion, when viewed from above the first surface, does not overlap the at least one antenna element.
